(19) United States
(12) Patent Application Publication
(10) Pub. No.: US 2025/0137511 A1
(43) Pub. Date: May 1, 2025

(54) SHOCK ABSORBER

(71) Applicant: Hitachi Astemo, Ltd., Hitachinaka-shi, Ibaraki (JP)

(72) Inventor: Mikio YAMASHITA, Hitachinaka-shi (JP)

(21) Appl. No.: 18/683,087

(22) PCT Filed: Jun. 27, 2022
(86) PCT No.: PCT/JP2022/025559

§ 371 Date: Feb. 12, 2024

(30) Foreign Application Priority Data
Sep. 8, 2021 (JP) 2021-145916

(51) Int. Cl. F16F 9/348; F16F 9/512

(52) U.S. Cl. CPC F16F 9/3485; F16F 9/5126

(57) ABSTRACT

This shock absorber includes a cylinder in which a working fluid is sealed, a piston fitted in the cylinder to be slidable and partitioning the inside of the cylinder into two chambers, a passage through which the working fluid flows from one chamber in the cylinder due to movement of the piston, a bendable plate-shaped valve member provided in the passage and whose inner circumferential side is supported by a support member only on one surface side without being clamped from both surface sides, and a movement restriction member restricting movement of the valve member. The support member is configured such that a spring constant of a second movement range in which the valve member moves to the movement restriction member side beyond a first movement range is larger than a spring constant of the first movement range in which the valve member moves to the movement restriction member side.

### TECHNICAL FIELD

The present invention relates to a shock absorber.

Priority is claimed on Japanese Patent Application No. 2021-145916 filed on Sep. 8, 2021, the contents of which are incorporated herein by reference.

### BACKGROUND ART

Some shock absorbers include a valve member with a simple support structure that is supported without being clamped in a passage through which a working fluid flows due to movement of a piston (see, for example, Patent Documents 1 and 2).

### CITATION LIST

### Patent Document

### [Patent Document 1]

Japanese Unexamined Patent Application, First Publication No. 2017-48825

### [Patent Document 2]

Japanese Patent No. 6722683

### SUMMARY OF INVENTION

### Technical Problem

In shock absorbers, it is required to improve ride comfort of a vehicle.

Therefore, an objective of the present invention is to provide a shock absorber capable of improving ride comfort of a vehicle.

### Solution to Problem

In order to achieve the above-described objective, the present invention employs the following aspect.

That is, a shock absorber according to one aspect of the present invention includes a cylinder in which a working fluid is sealed, a piston fitted in the cylinder to be slidable and partitioning an inside of the cylinder into two chambers, a passage through which the working fluid flows from one chamber in the cylinder due to movement of the piston, a bendable plate-shaped valve member provided in the passage and whose inner circumferential side is supported by a support member only on one surface side without being clamped from both surface sides, and a movement restriction member restricting movement of the valve member, in which the support member is configured such that a spring constant of a second movement range in which the valve member moves to the movement restriction member side beyond a first movement range is larger than a spring constant of the first movement range in which the valve member moves to the movement restriction member side.

### Advantageous Effects of Invention

According to the above-described aspect, it is possible to improve ride comfort of a vehicle.

### BRIEF DESCRIPTION OF DRAWINGS

FIG. 1 is a cross-sectional view illustrating a shock absorber of a first embodiment according to the present invention.

FIG. 2 is a partial cross-sectional view illustrating the vicinity of a piston of the shock absorber of the first embodiment according to the present invention.

FIG. 3 is a one-sided cross-sectional view illustrating a piston, a first damping force generation mechanism, a second damping force generation mechanism, and a frequency variable mechanism of the shock absorber of the first embodiment according to the present invention.

FIG. 4 is a partially enlarged cross-sectional view illustrating the frequency variable mechanism of the shock absorber of the first embodiment according to the present invention.

FIG. 5 is a partially enlarged cross-sectional view illustrating the frequency variable mechanism of the shock absorber of the first embodiment according to the present invention.

FIG. 6 is a characteristic diagram showing a relationship between a bending and a differential pressure of a valve disc of the shock absorber of the first embodiment according to the present invention.

FIG. 7 is a partially enlarged cross-sectional view illustrating the vicinity of a frequency variable mechanism of a shock absorber of a second embodiment according to the present invention.

FIG. 8 is a partially enlarged cross-sectional view illustrating the vicinity of a frequency variable mechanism of a shock absorber of a third embodiment according to the present invention.

### DESCRIPTION OF EMBODIMENTS

### First Embodiment

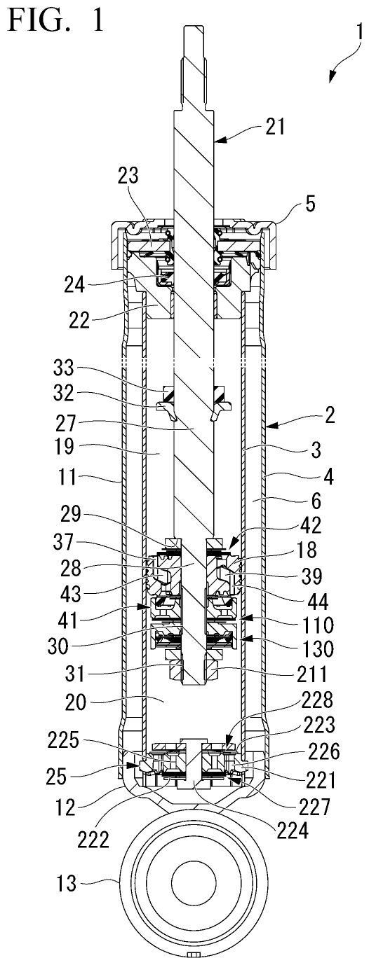

A shock absorber including a damping force generation mechanism of a first embodiment will be described below with reference to FIGS. 1 to 6. Further, in the following, for convenience of explanation, an upper side in FIGS. 1 to 3 will be referred to using “upper,” and a lower side in FIGS. 1 to 3 will be referred to using “lower”.

As illustrated in FIG. 1, a shock absorber 1 of the first embodiment is a dual-tube type hydraulic shock absorber. The shock absorber 1 is used in suspension devices of vehicles. The shock absorber 1 includes a cylinder 2 in which an oil fluid (not illustrated) is sealed as a working fluid. The cylinder 2 includes an inner cylinder 3 and an outer cylinder 4. The inner cylinder 3 has a cylindrical shape. The outer cylinder 4 has a bottomed cylindrical shape. The outer cylinder 4 has an inner diameter larger than an outer diameter of the inner cylinder 3. The inner cylinder 3 is disposed inside of the outer cylinder 4 in a radial direction. A central axis of the inner cylinder 3 and a central axis of the outer cylinder 4 coincide with each other. A reservoir chamber 6 is provided between the inner cylinder 3 and the outer cylinder 4. The shock absorber 1 includes a cover 5. The cover 5 covers an upper opening side of the outer cylinder 4.

The outer cylinder 4 includes a barrel member 11 and a bottom member 12. The barrel member 11 has a cylindrical shape. The bottom member 12 has a bottomed cylindrical shape. The bottom member 12 is fitted to a lower side of the barrel member 11 and fixed by welding. The bottom member 12 closes a lower portion of the barrel member 11. A mounting eye 13 is fixed to the bottom member 12 on an outer side opposite to the barrel member 11 in an axial direction thereof. The cover 5 is fixed to an outer circumferential surface of the barrel member 11 while covering an upper end opening portion of the barrel member 11.

The shock absorber 1 includes a piston 18. The piston 18 is slidably fitted into the inner cylinder 3 of the cylinder 2. The piston 18 partitions the inside of the inner cylinder 3 into two chambers, an upper chamber 19 and a lower chamber 20. In an axial direction of the cylinder 2, the upper chamber 19 is on a side opposite to the bottom member 12 with respect to the piston 18. In the axial direction of the cylinder 2, the lower chamber 20 is on the bottom member 12 side with respect to the piston 18. An oil fluid is sealed in the upper chamber 19 and the lower chamber 20 in the inner cylinder 3 as a working fluid. An oil fluid and a gas are sealed in the reservoir chamber 6 between the inner cylinder 3 and the outer cylinder 4 as a working fluid.

The shock absorber 1 includes a piston rod 21. One end side of the piston rod 21 in an axial direction thereof is disposed inside the inner cylinder 3 of the cylinder 2. This one end portion of the piston rod 21 is connected to the piston 18. The other end side of the piston rod 21 on a side opposite to the one end portion in the axial direction extends from the cylinder 2 to the outside of the cylinder 2. The piston 18 is fixed to the piston rod 21. Therefore, the piston 18 and the piston rod 21 move together. In the shock absorber 1, a stroke in which the piston rod 21 moves in a direction to increase an amount of protrusion from the cylinder 2 is referred to as an extension stroke in which the entire length increases. In the shock absorber 1, a stroke in which the piston rod 21 moves in a direction to decrease an amount of protrusion from the cylinder 2 is referred to as a compression stroke in which the entire length decreases. In the shock absorber 1, the piston 18 moves to the upper chamber 19 side during the extension stroke. In the shock absorber 1, the piston 18 moves to the lower chamber 20 side during the compression stroke.

A rod guide 22 is fitted to an upper end opening side of the inner cylinder 3 and an upper end opening side of the outer cylinder 4. A seal member 23 is fitted to the outer cylinder 4 on an upper side of the rod guide 22. A friction member 24 is provided between the rod guide 22 and the seal member 23. The rod guide 22, the seal member 23, and the friction member 24 are all annular. The piston rod 21 slides with respect to the rod guide 22, the friction member 24, and the seal member 23 in the axial direction of them. The piston rod 21 extends from the inside of the cylinder 2 to the outside of the cylinder 2 with respect to the seal member 23.

The rod guide 22 restricts movement of the piston rod 21 in the radial direction with respect to the inner cylinder 3 and outer cylinder 4 of the cylinder 2. The piston rod 21 is fitted in the rod guide 22 and the piston 18 is fitted in the inner cylinder 3. Thereby, a central axis of the piston rod 21 and a central axis of the cylinder 2 coincide with each other. The rod guide 22 supports the piston rod 21 to be movable in an axial direction of the piston rod 21. The seal member 23 has an outer circumferential portion in close contact with the outer cylinder 4. The seal member 23 has an inner circumferential portion in close contact with an outer circumferential portion of the piston rod 21. The piston rod 21 moves in an axial direction of the seal member 23 with respect to the seal member 23. The seal member 23 curbs the oil fluid in the inner cylinder 3 and the high-pressure gas and the oil fluid in the reservoir chamber 6 leaking to the outside. An inner circumferential portion of the friction member 24 is in contact with the outer circumferential portion of the piston rod 21. The piston rod 21 moves in an axial direction of the friction member 24 with respect to the friction member 24. The friction member 24 generates frictional resistance with respect to the piston rod 21.

An outer circumferential portion of the rod guide 22 has a larger diameter at an upper portion than at a lower portion. The rod guide 22 is fitted to an inner circumferential portion of an upper end of the inner cylinder 3 at the lower portion with a smaller diameter. The rod guide 22 is fitted to an upper inner circumferential portion of the outer cylinder 4 at the upper portion with a larger diameter. A base valve 25 is installed on the bottom member 12 of the outer cylinder 4. The base valve 25 is positioned in the radial direction with respect to the outer cylinder 4. The base valve 25 partitions the lower chamber 20 and the reservoir chamber 6. An inner circumferential portion of a lower end of the inner cylinder 3 is fitted to the base valve 25. Although not illustrated, a part of an upper end portion of the outer cylinder 4 is swaged inward in the radial direction of the outer cylinder 4. The seal member 23 is fixed to the cylinder 2 by being sandwiched between the swaged portion and the rod guide 22.

The piston rod 21 includes a main shaft part 27 and a mounting shaft part 28. The mounting shaft part 28 has an outer diameter smaller than an outer diameter of the main shaft part 27. The mounting shaft part 28 is disposed inside the cylinder 2. The piston 18 is attached to the mounting shaft part 28. The main shaft part 27 includes a shaft step part 29. The shaft step part 29 is provided at an end portion of the main shaft part 27 on the mounting shaft part 28 side. The shaft step part 29 extends in a direction orthogonal to the central axis of the piston rod 21. A passage groove 30 is formed in the piston rod 21 on an outer circumferential portion of the mounting shaft part 28. The passage groove 30 extends in an axial direction of the mounting shaft part 28. A plurality of passage grooves 30 are formed at intervals in a circumferential direction of the mounting shaft part 28. A male screw 31 is formed on an outer circumferential portion of an end portion of the mounting shaft part 28 on a side opposite to the main shaft part 27 with respect to the passage grooves 30 in the axial direction of the mounting shaft part 28.

An annular stopper member 32 and an annular buffer 33 are provided on the piston rod 21. Both the stopper member 32 and the buffer 33 are provided in a portion of the main shaft part 27 between the piston 18 and the rod guide 22. The piston rod 21 is inserted into an inner circumferential side of the stopper member 32 and the buffer 33. The stopper member 32 is swaged and fixed to the main shaft part 27. The buffer 33 is disposed between the stopper member 32 and the rod guide 22.

In the shock absorber 1, for example, a portion of the piston rod 21 protruding from the cylinder 2 is disposed at an upper portion and is connected to a vehicle body of a vehicle. At that time, the mounting eye 13 of the shock absorber 1 provided on the cylinder 2 side is disposed at a lower portion and is connected to a wheel side of the vehicle. Conversely, the cylinder 2 side of the shock absorber 1 may be connected to the vehicle body. In this case, the piston rod 21 of the shock absorber 1 is connected to the wheel side.

In the vehicle, the wheel vibrates with respect to the vehicle body as the vehicle travels. Then, in the shock absorber 1, positions of the cylinder 2 and the piston rod 21 change relative to each other according to the vibration. This change is suppressed by fluid resistance in a flow path provided in the shock absorber 1. As will be described below, the fluid resistance in the flow path provided in the shock absorber 1 is different according to a speed or an amplitude of the vibration described above. Ride comfort of the vehicle is improved by the shock absorber 1 suppressing the vibration.

Also, in the vehicle, an inertial force or a centrifugal force generated in the vehicle body as the vehicle travels also acts between the cylinder 2 and the piston rod 21 in addition to the vibration generated by the wheel with respect to the vehicle body. For example, a centrifugal force is generated in the vehicle body when a traveling direction is changed by a steering wheel operation. Then, a force based on the centrifugal force acts between the cylinder 2 and the piston rod 21. As will be described below, the shock absorber 1 has satisfactory properties against vibration based on the force generated in the vehicle body as the vehicle travels. High traveling stability of the vehicle can be obtained by the shock absorber 1.

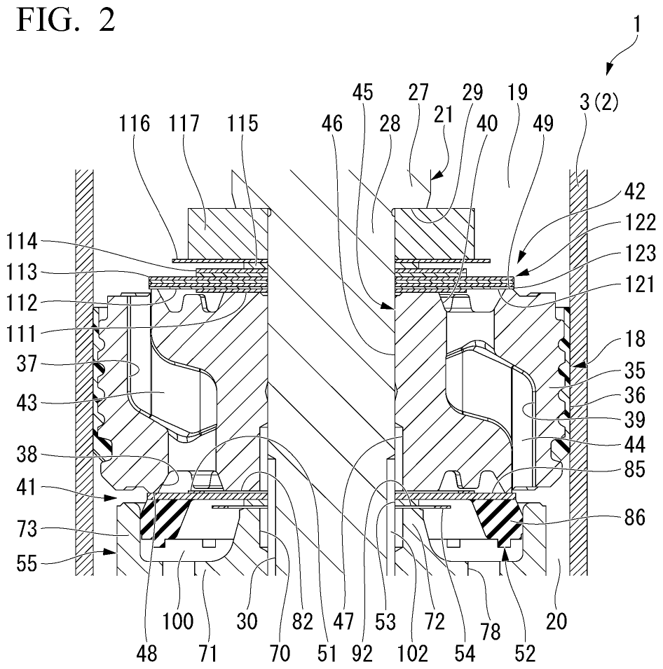

As illustrated in FIG. 2, the piston 18 includes a piston main body 35 and a slide member 36. The piston main body 35 is made of a metal and has an annular shape. The piston main body 35 of the piston 18 is fitted onto the piston rod 21. The slide member 36 is made of a synthetic resin and has an annular shape. The slide member 36 is integrally attached to an outer circumferential surface of the piston main body 35. The piston 18 slides with respect to the inner cylinder 3 with the slide member 36 in contact with the inner cylinder 3.

A passage hole 37, a passage groove 38, a passage hole 39, and a passage groove 40 are provided in the piston main body 35. The passage hole 37 penetrates the piston main body 35 in an axial direction of the piston main body 35. A plurality of passage holes 37 are formed in the piston main body 35 at intervals in a circumferential direction of the piston main body 35 (only one is illustrated in FIG. 2 because it is a cross section). The passage hole 39 penetrates the piston main body 35 in the axial direction of the piston main body 35. A plurality of passage holes 39 are formed in the piston main body 35 at intervals in the circumferential direction of the piston main body 35 (only one is illustrated in FIG. 2 because it is a cross section). In the piston main body 35, the passage holes 37 and the passage holes 39 are alternately formed one by one at a regular pitch in the circumferential direction of the piston main body 35.

The passage groove 38 is formed in the piston main body 35 in an annular shape in the circumferential direction of the piston main body 35. The passage groove 38 is formed at one end portion of the piston main body 35 in the axial direction. All the passage holes 37 open to the passage groove 38 at one end portions side thereof in the axial direction of the piston main body 35. The passage groove 40 is formed in the piston main body 35 in an annular shape in the circumferential direction of the piston main body 35. The passage groove 40 is formed at the other end portion of the piston main body 35 on a side opposite to the passage groove 38 in the axial direction. All the passage holes 39 open to the passage groove 40 at end portions on a side opposite to the passage groove 38 in the axial direction of the piston main body 35. The plurality of passage holes 37 at end portions on a side opposite to the passage groove 38 in the axial direction of the piston main body 35 open to an outer side of the passage groove 40 in a radial direction of the piston main body 35. The plurality of passage holes 39 at end portions on a side opposite to the passage groove 40 in the axial direction of the piston main body 35 open to an outer side of the passage groove 38 in the radial direction of the piston main body 35. In the piston 18, the inside of the plurality of passage holes 37 and the inside of the passage groove 38 form a first passage portion 43. In the piston 18, the inside of the plurality of passage holes 39 and the inside of the passage groove 40 form a first passage portion 44.

A first damping force generation mechanism 41 is provided in the first passage portion 43. The first damping force generation mechanism 41 opens and closes the first passage portion 43 to generate a damping force. The first damping force generation mechanism 41 is disposed on the lower chamber 20 side, which is one end side in the axial direction of the piston 18, and is attached to the piston rod 21. Thereby, the first passage portion 43 serves as a passage through which oil fluid as a working fluid flows from the upper chamber 19 toward the lower chamber 20 when the piston 18 moves to the upper chamber 19 side. In other words, the first passage portion 43 serves as a passage through which the oil fluid as a working fluid flows from the upper chamber 19 toward the lower chamber 20 during the extension stroke. The first damping force generation mechanism 41 is an extension-side damping force generation mechanism that generates a damping force by suppressing a flow of the oil fluid from the first passage portion 43 to the lower chamber 20 that occurs during the extension stroke.

A first damping force generation mechanism 42 is provided in the first passage portion 44. The first damping force generation mechanism 42 opens and closes the first passage portion 44 to generate a damping force. The first damping force generation mechanism 42 is disposed on the upper chamber 19 side, which is the other end side in the axial direction of the piston 18, and is attached to the piston rod 21. Thereby, the first passage portion 44 serves as a passage through which the oil fluid flows from the lower chamber 20 toward the upper chamber 19 when the piston 18 moves to the lower chamber 20 side. That is, the first passage portion 44 serves as a passage through which the oil fluid flows from the lower chamber 20 toward the upper chamber 19 during the compression stroke. The first damping force generation mechanism 42 is a compression-side damping force generation mechanism that generates a damping force by suppressing a flow of the oil fluid from the first passage portion 44 to the upper chamber 19 that occurs during the compression stroke.

The piston main body 35 has an insertion hole 45 formed at a center in the radial direction thereof to penetrate the piston main body 35 in the axial direction. The mounting shaft part 28 of the piston rod 21 is inserted through the insertion hole 45. The insertion hole 45 has a small diameter hole portion 46 and a large diameter hole portion 47. The large diameter hole portion 47 has a diameter larger than that of the small diameter hole portion 46. The mounting shaft part 28 of the piston rod 21 is fitted in the small diameter hole portion 46 of the piston main body 35. In an axial direction of the insertion hole 45, the large diameter hole portion 47 is on the lower chamber 20 side with respect to the small diameter hole portion 46.

A valve seat part 48 is formed at an end portion of the piston main body 35 on the lower chamber 20 side in the axial direction. The valve seat part 48 has an annular shape. The valve seat part 48 is disposed on an outer side with respect to an opening of the passage groove 38 on the lower chamber 20 side in the radial direction of the piston main body 35. The valve seat part 48 constitutes a part of the first damping force generation mechanism 41.

A valve seat part 49 is formed at an end portion of the piston main body 35 on the upper chamber 19 side in the axial direction. The valve seat part 49 has an annular shape. The valve seat part 49 is disposed on an outer side with respect to an opening of the passage groove 40 on the upper chamber 19 side in the radial direction of the piston main body 35. The valve seat part 49 constitutes a part of the first damping force generation mechanism 42.

In the piston main body 35, openings on the lower chamber 20 side in all the passage holes 39 are disposed on a side of the valve seat part 48 opposite to the passage groove 38 in the radial direction of the piston main body 35. In the piston main body 35, openings on the upper chamber 19 side in all the passage holes 37 are disposed on a side of the valve seat part 49 opposite to the passage groove 40 in the radial direction of the piston main body 35.

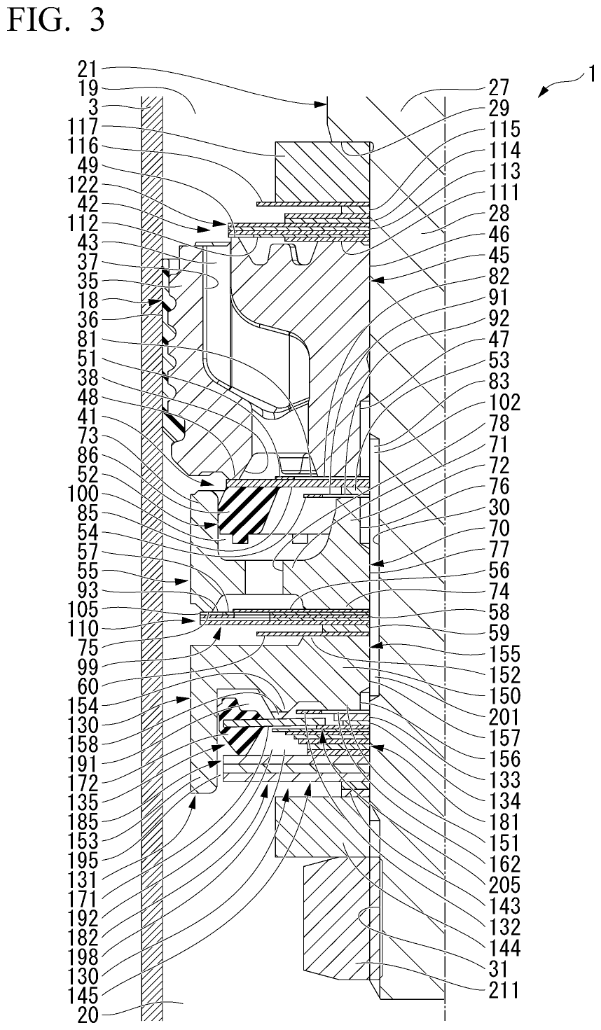

As illustrated in FIG. 3, one disc 51, one damping valve 52, one disc 53, one disc 54, one pilot case 55, one disc 56, one disc 57, a plurality of (specifically, three) discs 58, one disc 59, and one disc 60 are provided on the valve seat part 48 side in the axial direction of the piston 18 in order from the piston 18 side in the axial direction of the piston 18. The discs 51, 53, 54, 56 to 60, and the pilot case 55 are all made of a metal. The discs 51, 53, 54, and 56 to 60 are all formed in a bored circular flat plate shape each having a constant thickness. The mounting shaft part 28 of the piston rod 21 is fitted to an inner side of all the discs 51, 53, 54, and 56 to 60. Both the damping valve 52 and the pilot case 55 have an annular shape. The mounting shaft part 28 of the piston rod 21 is fitted to an inner side of both the damping valve 52 and the pilot case 55.

The pilot case 55 has a bottomed cylindrical shape. A through hole 70 is formed in the pilot case 55 at a center thereof in the radial direction. The through hole 70 penetrates the pilot case 55 in an axial direction thereof. The pilot case 55 has a bottom portion 71, an inner cylindrical portion 72, an outer cylindrical portion 73, an inner seat part 74, and a valve seat part 75.

The through hole 70 has a large diameter hole portion 76 and a small diameter hole portion 77. The large diameter hole portion 76 has a diameter larger than that of the small diameter hole portion 77. The large diameter hole portion 76 is disposed on the piston 18 side in an axial direction of the through hole 70. The small diameter hole portion 77 is disposed on a side opposite to the piston 18 with respect to the large diameter hole portion 76 in the axial direction of the through hole 70.

The bottom portion 71 has a bored disc shape. A passage hole 78 penetrating the bottom portion 71 in an axial direction of the bottom portion 71 is formed in the bottom portion 71 on a radially outer side of the through hole 70.

The inner cylindrical portion 72 has a cylindrical shape and protrudes from an inner circumferential edge portion of the bottom portion 71 to the piston 18 side in an axial direction of the bottom portion 71. The inner cylindrical portion 72 is provided on an inner side of the passage hole 78 in a radial direction of the bottom portion 71.

The outer cylindrical portion 73 has a cylindrical shape and protrudes from an outer circumferential edge portion of the bottom portion 71 to the same side as the inner cylindrical portion 72 in the axial direction of the bottom portion 71. The outer cylindrical portion 73 is provided on an outer side of the passage hole 78 in the radial direction of the bottom portion 71. The passage hole 78 is disposed between the inner cylindrical portion 72 and the outer cylindrical portion 73 in the radial direction of the bottom portion 71.

The inner seat part 74 is annular and protrudes from the inner circumferential edge portion of the bottom portion 71 to a side opposite to the inner cylindrical portion 72 in the axial direction.

The valve seat part 75 has an annular shape with a larger diameter than the inner seat part 74. The valve seat part 75 protrudes from the bottom portion 71 on an outer side in the radial direction of the inner seat part 74 to the same side as the inner seat part 74 in the axial direction of the bottom portion 71. The passage hole 78 is disposed between the inner seat part 74 and the valve seat part 75 in the radial direction of the bottom portion 71.

The disc 51 has an outer diameter smaller than an inner diameter of a distal end surface of the valve seat part 48. A notch 81 is formed in the disc 51. The notch 81 extends outward in the radial direction from the inner circumferential edge portion of the disc 51 fitted to the mounting shaft part 28 to the inside of the passage groove 38. The inside of the notch 81 serves as a throttle 82. The throttle 82 is in constant communication with the first passage portion 43 of the piston 18. A passage in the large diameter hole portion 47 of the piston 18 and a passage in the passage groove 30 of the piston rod 21 are in constant communication with each other. The passage in the large diameter hole portion 47 and the passage in the passage groove 30 constitute a rod chamber 83. The throttle 82 in the notch 81 of the disc 51 is in constant communication with the rod chamber 83. The throttle 82 allows constant communication between the first passage portion 43 and the rod chamber 83.

The damping valve 52 is formed of a disc 85 and a seal member 86.

The disc 85 is made of a metal and has a bored circular flat plate shape. The disc 85 has an outer diameter larger than an outer diameter of the distal end surface of the valve seat part 48. The mounting shaft part 28 of the piston rod 21 is fitted inside the disc 85. The disc 85 is in contact with the valve seat part 48 of the piston 18, and opens and closes an opening of the first passage portion 43 formed in the piston 18 by being separated from and coming into contact with the valve seat part 48.

The seal member 86 is made of rubber and is adhered to the disc 85. The seal member 86 is fixed to an outer circumferential side of the disc 85 and has an annular shape. The seal member 86 is fitted in a liquid-tight manner to an inner circumferential portion of the outer cylindrical portion 73 of the pilot case 55 over the entire circumference. The seal member 86 is slidable with respect to the inner circumferential portion of the outer cylindrical portion 73 in the axial direction. The seal member 86 constantly seals a gap between the damping valve 52 and the outer cylindrical portion 73.

The disc 53 has an outer diameter smaller than a minimum inner diameter of the seal member 86. The disc 54 has an outer diameter larger than the outer diameter of the disc 53 and smaller than the minimum inner diameter of the seal member 86. A notch 91 is formed in the disc 54. The notch 91 extends outward in the radial direction from an inner circumferential edge portion of the disc 54 fitted to the mounting shaft part 28 to an outer side of the disc 53. The inside of the notch 91 serves as a throttle 92. The throttle 92 is in constant communication with the passage in the passage groove 30 of the piston rod 21 and a passage in the large diameter hole portion 76 of the pilot case 55.

The disc 56 has an outer diameter smaller than an inner diameter of a distal end surface of the valve seat part 75 of the pilot case 55. The disc 57 has an outer diameter larger than an outer diameter of the distal end surface of the valve seat part 75. The disc 57 can be seated on the valve seat part 75. A notch 93 is formed on an outer circumferential side of the disc 57. The notch 93 crosses the valve seat part 75 in the radial direction. The disc 58 has an outer diameter that is the same as the outer diameter of the disc 57. The disc 59 has an outer diameter smaller than the outer diameter of the disc 58. The disc 60 has an outer diameter larger than the outer diameter of the disc 59 and smaller than the outer diameter of the disc 58. The discs 57 and 58 constitute a disc valve 99. The disc valve 99 can be separated from and seated on the valve seat part 75.

The bottom portion 71, the inner cylindrical portion 72, and the outer cylindrical portion 73 of the pilot case 55, a space between the damping valve 52 and the discs 53 and 54, the bottom portion 71, the inner seat part 74, and the valve seat part 75 of the pilot case 55, a space between the disc 56 and the disc valve 99, and the inside of the passage hole 78 of the pilot case 55 serve as a back pressure chamber 100. The back pressure chamber 100 applies a pressure to the damping valve 52 in a direction of the piston 18. In other words, the back pressure chamber 100 applies an internal pressure to the damping valve 52 in a valve closing direction in which the damping valve 52 is seated on the valve seat part 48. The damping valve 52 is a pilot type damping valve having the back pressure chamber 100. These damping valve 52 and the back pressure chamber 100 constitute a part of the first damping force generation mechanism 41. The back pressure chamber 100 is in constant communication with the rod chamber 83 via the throttle 92 in the notch 91 of the disc 54. The passage in the large diameter hole portion 76 of the pilot case 55 is in constant communication with the passage in the passage groove 30 of the piston rod 21. The passage in the large diameter hole portion 76 of the pilot case 55 also constitutes the rod chamber 83.

The throttle 82 in the notch 81 of the disc 51, the rod chamber 83, and the throttle 92 in the notch 91 of the disc 54 allow constant communication between the first passage portion 43 of the piston 18 and the back pressure chamber 100, thereby forming a second passage portion 102 that introduces the oil fluid into the back pressure chamber 100 from the first passage portion 43. When the disc 85 is separated from the valve seat part 48 of the piston 18 and opens, the damping valve 52 allows the oil fluid to flow from the first passage portion 43 to the lower chamber 20 through between the piston 18 and the outer cylindrical portion 73 of the pilot case 55. At that time, the damping valve 52 suppresses a flow of the oil fluid between itself and the valve seat part 48. The extension-side first damping force generation mechanism 41 introduces some of the flow of the oil fluid into the back pressure chamber 100 through the second passage portion 102, and controls opening of the damping valve 52 using a pressure in the back pressure chamber 100.

The disc valve 99 allows the back pressure chamber 100 and the lower chamber 20 to communicate with each other by being separated from the valve seat part 75. At that time, the disc valve 99 suppresses a flow of oil fluid between itself and the valve seat part 75. A passage in the notch 93 of the disc valve 99 constitutes a fixed orifice 105 that allows the back pressure chamber 100 to communicate with the lower chamber 20 even when the disc valve 99 is in contact with the valve seat part 75. When the disc valve 99 deforms in an opening direction, the disc 60 suppresses deformation of the disc valve 99 beyond a specified limit by coming into contact with the disc valve 99.

The disc valve 99 and the valve seat part 75 constitute a second damping force generation mechanism 110. The second damping force generation mechanism 110 allows the back pressure chamber 100 and the lower chamber 20 to communicate with each other when the disc valve 99 is separated from the valve seat part 75. At that time, the second damping force generation mechanism 110 generates a damping force by suppressing a flow of the oil fluid between the back pressure chamber 100 and the lower chamber 20. The second damping force generation mechanism 110 is provided between the back pressure chamber 100 and the lower chamber 20 and generates a damping force due to the flow of the oil fluid. In the extension stroke, the second damping force generation mechanism 110 causes the oil fluid to flow from the upper chamber 19 to the lower chamber 20 via the first passage portion 43, the second passage portion 102, and the back pressure chamber 100. The second damping force generation mechanism 110 serves as an extension-side damping force generation mechanism that generates a damping force by suppressing a flow of the oil fluid from the back pressure chamber 100 to the lower chamber 20 that occurs during the extension stroke.

As illustrated in FIG. 2, one disc 111, one disc 112, a plurality of (specifically, three) discs 113, a plurality of (specifically, two) discs 114, one disc 115, one disc 116, and one annular member 117 are provided on the valve seat part 49 side in the axial direction of the piston 18 in order from the piston 18 side in the axial direction of the piston 18. The discs 111 to 116 and the annular member 117 are all made of a metal. The discs 111 to 116 and the annular member 117 are all formed in a bored circular flat plate shape each having a constant thickness. The mounting shaft part 28 of the piston rod 21 is fitted to an inner side of all the discs 111 to 116 and the annular member 117.

The disc 111 has an outer diameter smaller than an inner diameter of a distal end surface of the valve seat part 49 of the piston 18. The disc 112 has an outer diameter that is slightly larger than an outer diameter of the distal end surface of the valve seat part 49 of the piston 18. The disc 112 can be seated on the valve seat part 49. A notch 121 is formed on an outer circumferential side of the disc 112. The notch 121 crosses the valve seat part 49 in the radial direction.

The plurality of discs 113 have an outer diameter that is the same as the outer diameter of the disc 112. The plurality of discs 114 have an outer diameter smaller than the outer diameter of the discs 113. The disc 115 has an outer diameter smaller than the outer diameter of the discs 114. The disc 116 has an outer diameter larger than the outer diameter of the discs 114 and smaller than the outer diameter of the discs 113. The annular member 117 has an outer diameter smaller than the outer diameter of the disc 116 and larger than the outer diameter of the discs 114. The annular member 117 has a larger thickness and a higher rigidity than the discs 111 to 116. This annular member 117 is in contact with the shaft step part 29 of the piston rod 21.

The discs 112 to 114 constitute a disc valve 122. The disc valve 122 can be separated from and seated on the valve seat part 49. The disc valve 122 can open the first passage portion 44 to the upper chamber 19 by being separated from the valve seat part 49. At that time, the disc valve 122 suppresses a flow of the oil fluid from the lower chamber 20 to the upper chamber 19 via the first passage portion 44. The disc valve 122 and the valve seat part 49 constitute the compression-side first damping force generation mechanism 42. The notch 121 in the disc 112 constitutes a fixed orifice 123. The fixed orifice 123 allows the lower chamber 20 and the upper chamber 19 to communicate with each other even when the disc 112 is in contact with the valve seat part 49. The fixed orifice 123 also constitutes the first damping force generation mechanism 42.

When the disc valve 122 deforms in an opening direction of the disc valve 122, the disc 116 suppresses deformation of the disc valve 122 beyond a specified limit by coming into contact with the disc valve 122.

As illustrated in FIG. 3, a frequency sensitive mechanism 130 is provided on a side of the disc 60 opposite to the disc 59 in the axial direction. The frequency sensitive mechanism 130 makes the damping force variable according to a frequency of axial movement of the piston 18 (hereinafter referred to as a piston frequency).

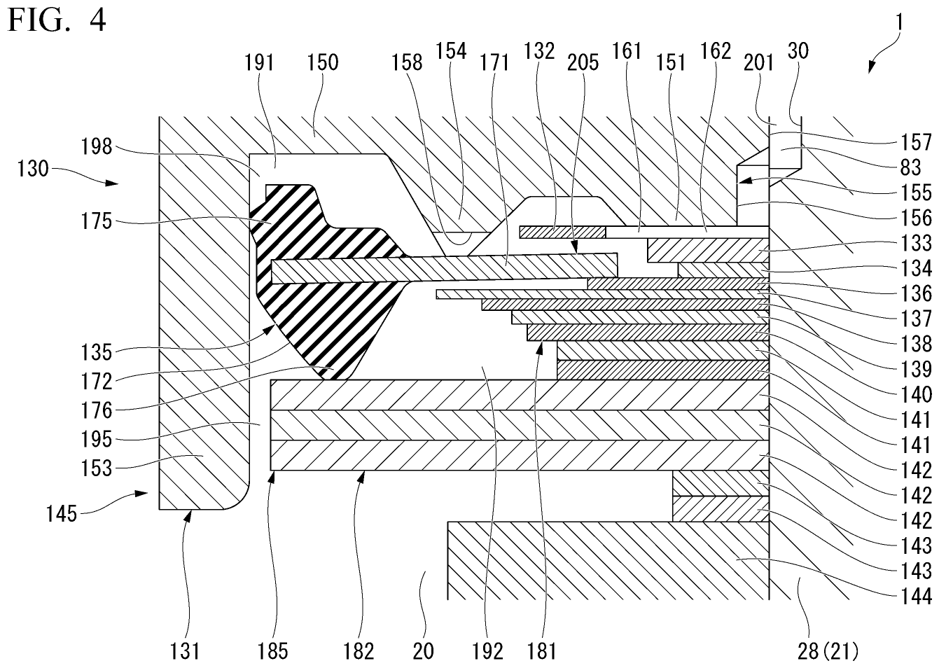

The frequency sensitive mechanism 130 includes one housing main body 131, one disc 132, one disc 133, one disc 134, and one partition disc 135 in order from the disc 60 side in the axial direction. As illustrated in FIG. 4, the frequency sensitive mechanism 130 includes one disc 136 (plate-shaped member), one disc 137 (plate-shaped member), one disc 138 (plate-shaped member), one disc 139 (plate-shaped member), one disc 140 (plate-shaped member), a plurality of (specifically, two) discs 141 (plate-shaped members), and a plurality of (specifically, three) discs 142 on a side of the disc 134 and the partition disc 135 opposite to the disc 132 in the axial direction in order from the side of the disc 134 and the partition disc 135.

A plurality of discs 143 are provided on a side of the plurality of discs 142 opposite to the discs 141 in the axial direction. An annular member 144 is provided on a side of the plurality of discs 143 opposite to the discs 142 in the axial direction.

The housing main body 131, the discs 132 to 134 and 136 to 143, and the annular member 144 are all made of a metal. The discs 132 to 134 and 136 to 143 and the annular member 144 are all formed in a bored circular flat plate shape each having a constant thickness. The mounting shaft part 28 of the piston rod 21 is fitted to an inner side of all the discs 132 to 134 and 136 to 143, the housing main body 131, and the annular member 144. The mounting shaft part 28 of the piston rod 21 is inserted through an inner circumferential side of the partition disc 135. The discs 132 to 134 and 136 to 142 and the housing main body 131 constitute a housing 145 of the frequency sensitive mechanism 130.

As illustrated in FIG. 3, the housing main body 131 has a bottomed cylindrical shape.

The housing main body 131 has a through hole 155 formed to penetrate the housing main body 131 in an axial direction thereof at a center in the radial direction. The through hole 155 has a large diameter hole portion 156 and a small diameter hole portion 157. The large diameter hole portion 156 has a diameter larger than that of the small diameter hole portion 157. The large diameter hole portion 156 is disposed on a side opposite to the disc 60 in the axial direction of the through hole 155. The small diameter hole portion 157 is disposed on the disc 60 side with respect to the large diameter hole portion 156 in the axial direction of the through hole 155. A passage in the large diameter hole portion 156 of the housing main body 131 is in constant communication with the passage in the passage groove 30 of the piston rod 21. The passage in the large diameter hole portion 156 of the housing main body 131 also constitutes the rod chamber 83.

The housing main body 131 includes a bottom portion 150, an one side protruding part 151, the other side protruding part 152, a cylindrical portion 153, and a seat part 154.

The bottom portion 150 has a bored disc shape.

The one side protruding part 151 has an annular shape. The one side protruding part 151 protrudes from an inner circumferential edge portion of the bottom portion 150 to a side opposite to the disc 60 in an axial direction of the bottom portion 150.

The other side protruding part 152 has an annular shape. The other side protruding part 152 protrudes from an inner circumferential edge portion of the bottom portion 150 to a side opposite to the one side protruding part 151 in the axial direction of the bottom portion 150.

The cylindrical portion 153 has a cylindrical shape. The cylindrical portion 153 extends from an outer circumferential edge portion of the bottom portion 150 to the same side as the one side protruding part 151 in the axial direction of the bottom portion 150.

The seat part 154 has an annular shape. The seat part 154 protrudes from a position between the one side protruding part 151 and the cylindrical portion 153 in a radial direction of the bottom portion 150 to the same side as the one side protruding part 151 and the cylindrical portion 153 in the axial direction of the bottom portion 150. A notch 158 penetrating the seat part 154 in the radial direction is formed in the seat part 154 at an end portion thereof on a protrusion distal end side.

As illustrated in FIG. 4, the disc 132 has an outer diameter larger than an outer diameter of a distal end surface of the one side protruding part 151 and smaller than an inner diameter of a distal end surface of the seat part 154. A notch 161 is formed in the disc 132. The notch 161 extends outward in the radial direction from an inner circumferential edge portion of the disc 132 fitted to the mounting shaft part 28 to an outer side of the distal end surface of the one side protruding part 151. The inside of the notch 161 serves as a throttle 162. The throttle 162 is in constant communication with the passage in the large diameter hole portion 156 of the housing main body 131. Therefore, the throttle 162 is in constant communication with the rod chamber 83.

The disc 133 has an outer diameter smaller than the outer diameter of the disc 132. The notch 161 of the disc 132 extends to a radially outer side of the disc 133 in a radial direction of the disc 132. The disc 133 has a larger thickness than the disc 132.

The disc 134 has an outer diameter smaller than the outer diameter of the disc 133. The disc 134 has a smaller thickness than the disc 133.

The partition disc 135 is formed of a valve disc 171 (valve member) and an elastic seal member 172 (elastic member, seal member). The partition disc 135 is disposed inside the cylindrical portion 153 of the housing main body 131. The partition disc 135 is disposed between the cylindrical portion 153 and the discs 133 and 134 in the radial direction.

The valve disc 171 is made of a metal. The valve disc 171 has a bored circular flat plate shape with a constant thickness. The valve disc 171 has an annular shape with a constant width in the radial direction. The mounting shaft part 28 of the piston rod 21 is inserted through an inner circumferential side of the valve disc 171. The valve disc 171 is disposed inside the cylindrical portion 153 of the housing main body 131. The valve disc 171 is elastically deformable, that is, bendable. The valve disc 171 has an inner diameter larger than the outer diameter of the disc 133. The valve disc 171 has an inner diameter in which the discs 133 and 134 can be disposed on an inner side thereof with a gap in the radial direction. The valve disc 171 has a smaller thickness than the two discs 133 and 134. The valve disc 171 has an outer diameter larger than an outer diameter of the distal end surface of the seat part 154 of the housing main body 131.

The elastic seal member 172 is made of rubber and has an annular shape. The elastic seal member 172 is adhered to an outer circumferential side of the valve disc 171. The elastic seal member 172 is provided integrally with the valve disc 171 by being baked into the valve disc 171. The elastic seal member 172 includes a seal part 175 and a plurality of contact parts 176. The seal part 175 has an annular shape and is fixed to the outer circumferential side of the valve disc 171 over the entire circumference. The seal part 175 protrudes from the valve disc 171 to a side of the bottom portion 150 of the housing main body 131 in an axial direction of the partition disc 135. The plurality of contact parts 176 are fixed to the outer circumferential side of the valve disc 171. The plurality of contact parts 176 are disposed at regular intervals in a circumferential direction of the valve disc 171. The plurality of contact parts 176 protrude from the valve disc 171 to a side opposite to the bottom portion 150 in the axial direction of the partition disc 135.

An annular gap is provided between the valve disc 171 and the cylindrical portion 153 of the housing main body 131. The seal part 175 and the plurality of contact parts 176 of the elastic seal member 172 are fixed to both surfaces of the valve disc 171 through the gap. With such a configuration, fixing of the seal part 175 and the plurality of contact parts 176 to the valve disc 171 is facilitated.

The seal part 175 of the elastic seal member 172 is fitted in a liquid-tight manner to an inner circumferential portion of the cylindrical portion 153 of the housing main body 131 over the entire circumference. The seal part 175 is slidable with respect to the cylindrical portion 153 in an axial direction of the cylindrical portion 153. The seal part 175 of the elastic seal member 172 constantly seals the gap between the partition disc 135 and the cylindrical portion 153. A minimum inner diameter of the seal part 175 is larger than the outer diameter of the distal end surface of the seat part 154. The valve disc 171 of the partition disc 135 can be seated on the seat part 154 of the housing main body 131.

The disc 136 has an outer diameter larger than an inner diameter of the valve disc 171. The disc 136 has a smaller thickness than the disc 134. The disc 136 has a smaller thickness than the valve disc 171. The disc 136 is in contact with an inner circumferential side of the valve disc 171 over the entire circumference. Thereby, a gap between the disc 136 and the valve disc 171 is closed. The inner circumferential side of the valve disc 171 of the partition disc 135 is disposed between the disc 132 and the disc 136, and is in contact with and supported by the disc 136. The inner circumferential side of the valve disc 171 of the partition disc 135 is movable between the disc 132 and the disc 136 within a range of an axial length of the two discs 133 and 134. The partition disc 135 is centered with respect to the housing 145 by the seal part 175 in contact with the cylindrical portion 153 over the entire circumference. The inner circumferential side of the valve disc 171 of the partition disc 135 is supported by the disc 136 only on one surface side without being clamped from both surface sides. The partition disc 135 is supported by the seat part 154 only on one surface side without being clamped from both surface sides at a radially outer side of the valve disc 171 with respect to the disc 136. Therefore, the partition disc 135 has a simple support structure in which one surface side of the valve disc 171 is supported by the disc 136 and the other surface side of the valve disc 171 is supported by the seat part 154. The partition disc 135 has an annular shape as a whole and is elastically deformable, that is, bendable.

The disc 137 has an outer diameter larger than the outer diameter of the disc 136 and smaller than a minimum inner diameter of the contact part 176. The disc 137 has a smaller thickness than the disc 136. The disc 138 has an outer diameter smaller than the outer diameter of the disc 137. The disc 138 has a larger thickness than the disc 137. The disc 139 has an outer diameter smaller than the outer diameter of the disc 138. The disc 139 has a larger thickness than the disc 138. The disc 140 has an outer diameter smaller than the outer diameter of the disc 139. The disc 140 has a larger thickness than the disc 139. The disc 141 has an outer diameter smaller than the outer diameter of the disc 140 and larger than the outer diameter of the disc 136. The disc 141 has a larger thickness than the disc 140.

The discs 136 to 141, all of which are plate-shaped members, are stacked to form a support member 181. The support member 181 includes the contact parts 176 of the partition disc 135. In the discs 137 to 141 of the discs 136 to 141, an outer diameter on a side opposite to the valve disc 171 in the axial direction is smaller than an outer diameter on the valve disc 171 side in the axial direction. In the discs 137 to 141, a thickness on a side opposite to the valve disc 171 in the axial direction is larger than that on the valve disc 171 side in the axial direction. The support member 181 supports the inner circumferential side of the valve disc 171 of the partition disc 135. The inner circumferential side of the valve disc 171 of the partition disc 135 is supported by the support member 181 only on one surface side in the axial direction without being clamped from both surface sides in the axial direction.

The plurality of discs 142 have an outer diameter larger than the outer diameter of the disc 141 and smaller than an inner diameter of the cylindrical portion 153. The disc 142 has a larger thickness than the disc 141. The plurality of discs 142 are in constant contact with the contact parts 176 of the partition disc 135. The plurality of discs 142 constitute a stopper member 182. The stopper member 182 restricts movement of the valve disc 171 to a side opposite to the seat part 154 in the axial direction of the housing main body 131 with the contact parts 176 of the elastic seal member 172. An inner circumferential side of the stopper member 182 is fixed to the piston rod 21. The inner circumferential side of the stopper member 182 is non-movable with respect to the housing main body 131. The contact parts 176 of the elastic seal member 172 are extendable and contractible with respect to the housing main body 131 in the axial direction of the housing main body 131. In the elastic seal member 172, end portions of the contact parts 176 on the stopper member 182 side are movable with respect to the piston rod 21 and the housing main body 131. Since the elastic seal member 172 is adhered to the valve disc 171, the elastic seal member 172 is in constant contact with the valve disc 171. The contact parts 176 of the elastic seal member 172 and the stopper member 182 are in constant contact with each other. The contact parts 176 of the elastic seal member 172 and the stopper member 182 constitute a movement restriction member 185 that restricts movement of the valve disc 171.

In the discs 137 to 141 of the support member 181, an outer diameter on the movement restriction member 185 side in the axial direction of the support member 181 is smaller than an outer diameter on the valve disc 171 side in the axial direction of the support member 181. In the discs 137 to 141, a thickness on the movement restriction member 185 side in the axial direction of the support member 181 is larger than a thickness on the valve disc 171 side in the axial direction of the support member 181.

A communication passage 195 is provided between the discs 142 and the cylindrical portion 153 in the radial direction. The communication passage 195 is in constant communication with the lower chamber 20. The communication passage 195 is disposed on a radially outer side with respect to the contact parts 176 of the elastic seal member 172 that is in contact with the discs 142.

The seal part 175 of the partition disc 135 is in contact with an inner circumferential surface of the cylindrical portion 153 of the housing main body 131 over the entire circumference. Thereby, the seal part 175 seals the gap between the partition disc 135 and the cylindrical portion 153. That is, the partition disc 135 is a packing valve. The seal part 175 constantly seals the gap between the partition disc 135 and the cylindrical portion 153 even if the partition disc 135 is deformed within an allowable range in the housing 145. The partition disc 135 is centered with respect to the housing 145 as described above by the seal part 175 in contact with the cylindrical portion 153 over the entire circumference. The partition disc 135 closes the gap between itself and the disc 136 when the valve disc 171 thereof comes into contact with the disc 136 over the entire circumference.

The seat part 154 of the housing main body 131 supports the valve disc 171 of the partition disc 135 from one side in the axial direction. In the support member 181, the disc 136 supports the inner circumferential side of the valve disc 171 with respect to the seat part 154 from the other side in the axial direction. A shortest distance in the axial direction between the seat part 154 and the disc 136 is smaller than a thickness of the valve disc 171 in the axial direction. Therefore, the valve disc 171 is pressed against the seat part 154 and the disc 136 over the entire circumference by its own elastic force while being slightly elastically deformed.

The partition disc 135 partitions the inside of the housing 145 into a variable chamber 191 and a variable chamber 192. The variable chamber 191 is between the bottom portion 150 side of the housing main body 131 and the partition disc 135. The variable chamber 192 is between the partition disc 135 and the discs 142. Both the variable chamber 191 and the variable chamber 192 are variable in capacity, and capacities thereof change due to deformation of the partition disc 135. In other words, the two variable chambers 191 and 192 are defined by the partition disc 135 and are provided in the housing 145. The variable chamber 191 is in constant communication with the rod chamber 83 via the throttle 162 in the notch 161 of the disc 132. Therefore, the variable chamber 191 is in constant communication with the upper chamber 19 via the throttle 162 in the disc 132, the rod chamber 83, and the throttle 82 in the disc 51 and the first passage portion 43 illustrated in FIG. 3. Also, the variable chamber 191 is in constant communication with the back pressure chamber 100 via the throttle 162 in the disc 132, the rod chamber 83, and the throttle 92 in the disc 54. The variable chamber 192 is in constant communication with the lower chamber 20 via the communication passage 195. The variable chamber 191 and the variable chamber 192 constitute a housing inner chamber 198 provided in the housing 145. The partition disc 135 is provided in the housing inner chamber 198.

In the partition disc 135, the plurality of contact parts 176 illustrated in FIG. 4 are disposed at intervals in the circumferential direction. Thereby, in the variable chamber 192, an inner side and an outer side of the contact parts 176 in the radial direction are in constant communication with each other. Also, the notch 158 is provided in the seat part 154 of the housing main body 131. Thereby, in the variable chamber 191, an inner side and an outer side of the seat part 154 in the radial direction are in constant communication with each other. Thereby, pressure receiving areas on a side of the valve disc 171 in which the seal part 175 is provided and on a side of the valve disc 171 in which the contact parts 176 are provided are the same level as each other.

In the extension stroke, the oil fluid from the upper chamber 19 illustrated in FIG. 3 is introduced into the variable chamber 191 via the first passage portion 43, the throttle 82 in the disc 51, the rod chamber 83, and the throttle 162 in the disc 132. Then, the valve disc 171 of the partition disc 135 is deformed into a tapered shape such that an outer circumferential side thereof is separated from the seat part 154 in an axial direction of the seat part 154 using a contact point with the disc 136 illustrated in FIG. 4 of the support member 181 as a fulcrum. In other words, the valve disc 171 moves to the movement restriction member 185 side while being deformed. At that time, the valve disc 171 compressively deforms the contact parts 176 of the elastic seal member 172 that are in contact with the stopper member 182. In other words, the valve disc 171 deforms so that an outer circumferential side thereof moves in a direction of the stopper member 182 and the contact parts 176. Due to this deformation movement of the valve disc 171, a volume of the variable chamber 191 increases.

At that time, the support member 181 including the contact parts 176 supporting the valve disc 171 provides a resistance force to the deformation movement of the valve disc 171. In other words, the support member 181 restricts a lift of the valve disc 171. Here, during this deformation movement of the valve disc 171, a volume of the variable chamber 192 is reduced. At that time, the oil fluid in the variable chamber 192 flows into the lower chamber 20 via the communication passage 195.

At the beginning of the deformation movement to the movement restriction member 185 side, the valve disc 171 itself deforms and moves and compressively deforms the contact parts 176 of the elastic seal member 172 that are in contact with the stopper member 182. A movement range during this deformation movement of the valve disc 171 is defined as a first movement range. In this first movement range, a spring constant of the support member 181 is a spring constant of the contact part 176. This spring constant is defined as a first spring constant.

When the deformation movement of the valve disc 171 to the movement restriction member 185 side progresses further, the valve disc 171 itself deforms and moves beyond the first movement range, and compressively deforms the contact parts 176 of the elastic seal member 172 beyond the first movement range. At the same time, the valve disc 171 comes into contact with an outer circumferential side of the disc 137 of the support member 181, and causes the outer circumferential side of the disc 137 to be deformed and moved in a tapered shape to the movement restriction member 185 side. A movement range during this deformation movement of the valve disc 171 is defined as a second movement range. A spring constant of the support member 181 in the second movement range is defined as a second spring constant. Then, the second spring constant is a combined spring constant of the spring constant of the contact parts 176 and the spring constant of the disc 137, and is larger than the first spring constant. In other words, a rigidity of the support member 181 when the valve disc 171 is in the second movement range is higher than a rigidity thereof when the valve disc 171 is in the first movement range.

When the deformation movement of the valve disc 171 to the movement restriction member 185 side progresses further, the valve disc 171 itself deforms and moves beyond the second movement range, and compressively deforms the contact parts 176 of the elastic seal member 172 beyond the second movement range. At the same time, the valve disc 171 causes the outer circumferential side of the disc 137 of the support member 181 to be deformed and moved in a tapered shape to the movement restriction member 185 side beyond the second movement range. At the same time, the valve disc 171 causes the outer circumferential side of the disc 138 to be deformed and moved in a tapered shape to the movement restriction member 185 side via the disc 137. A movement range during the deformation movement of the valve disc 171 to the movement restriction member 185 side following the second movement range is defined as a third movement range. A spring constant of the support member 181 in this third movement range is defined as a third spring constant. Then, the third spring constant is a combined spring constant of the spring constant of the contact parts 176, the spring constant of the disc 137, and the spring constant of the disc 138, and is larger than the second spring constant. In other words, a rigidity of the support member 181 when the valve disc 171 is in the third movement range is higher than the rigidity thereof when the valve disc 171 is in the second movement range.

When the deformation movement of the valve disc 171 to the movement restriction member 185 side progresses further, the valve disc 171 itself deforms and moves beyond the third movement range, and compressively deforms the contact parts 176 of the elastic seal member 172 beyond the third movement range. At the same time, the valve disc 171 causes the outer circumferential side of the disc 137 of the support member 181 to be deformed and moved in a tapered shape to the movement restriction member 185 side beyond the third movement range. At the same time, the valve disc 171 causes the outer circumferential side of the disc 138 to be deformed and moved in a tapered shape to the movement restriction member 185 side beyond the third movement range via the disc 137. At the same time, the valve disc 171 causes an outer circumferential side of the disc 139 to be deformed and moved in a tapered shape to the movement restriction member 185 side via the disc 138. A movement range during the deformation movement of the valve disc 171 to the movement restriction member 185 side following the third movement range is defined as a fourth movement range. A spring constant of the support member 181 in the fourth movement range is defined as a fourth spring constant. Then, the fourth spring constant is a combined spring constant of the spring constant of the contact parts 176, the spring constant of the disc 137, the spring constant of the disc 138, and the spring constant of the disc 139, and is larger than the third spring constant. In other words, a rigidity of the support member 181 when the valve disc 171 is in the fourth movement range is higher than the rigidity thereof when the valve disc 171 is in the third movement range.

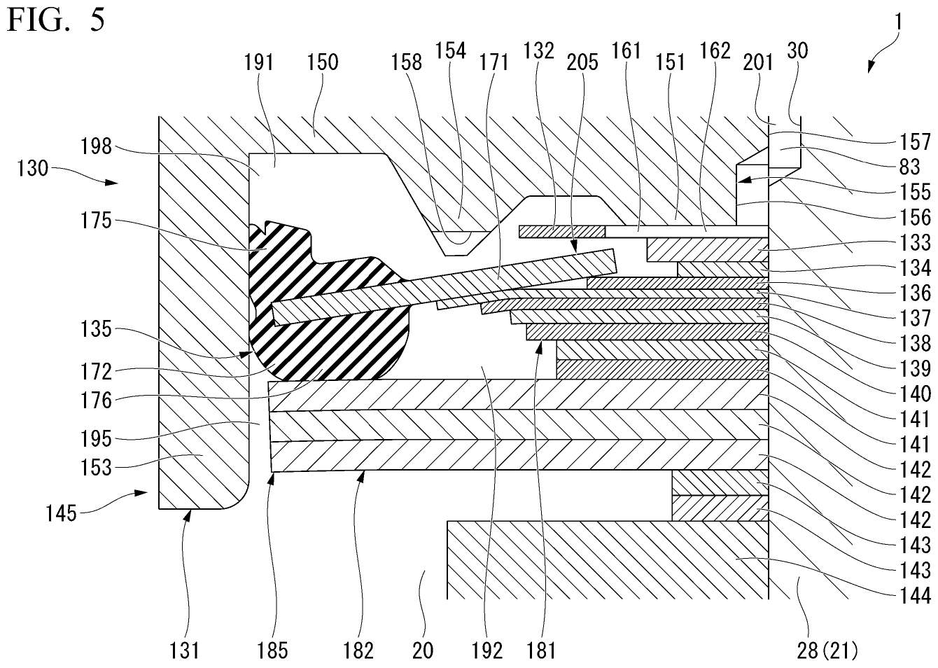

As the deformation movement of the valve disc 171 to the movement restriction member 185 side progresses further, the valve disc 171 itself deforms and moves beyond the fourth movement range, and compressively deforms the contact parts 176 of the elastic seal member 172 beyond the fourth movement range as illustrated in FIG. 5. At the same time, the valve disc 171 causes the outer circumferential side of the disc 137 of the support member 181 to be deformed and moved in a tapered shape to the movement restriction member 185 side beyond the fourth movement range. At the same time, the valve disc 171 causes the outer circumferential side of the disc 138 to be deformed and moved in a tapered shape to the movement restriction member 185 side beyond the fourth movement range via the disc 137. At the same time, the valve disc 171 causes the outer circumferential side of the disc 139 to be deformed and moved in a tapered shape to the movement restriction member 185 side beyond the fourth movement range via the disc 138. At the same time, the valve disc 171 causes the outer circumferential side of the disc 140 to be deformed and moved in a tapered shape to the movement restriction member 185 side via the disc 139. A movement range during the deformation movement of the valve disc 171 to the movement restriction member 185 side following the fourth movement range is defined as a fifth movement range. A spring constant of the support member 181 in the fifth movement range is defined as a fifth spring constant. Then, the fifth spring constant is a combined spring constant of the spring constant of the contact parts 176, the spring constant of the disc 137, the spring constant of the disc 138, the spring constant of the disc 139, and the spring constant of the disc 140, and is larger than the fourth spring constant. In other words, a rigidity of the support member 181 when the valve disc 171 is in the fifth movement range is higher than the rigidity thereof when the valve disc 171 is in the fourth movement range.

The discs 143 have an outer diameter smaller than the outer diameter of the discs 142. The annular member 144 has an outer diameter larger than the outer diameter of the discs 143 and smaller than the outer diameter of the discs 142.

The first passage portion 43, the throttle 82, the rod chamber 83, the throttle 162, the housing inner chamber 198, and the communication passage 195 illustrated in FIG. 3 constitute a passage 201. The passage 201 allows the upper chamber 19 and the lower chamber 20 to communicate with each other. In the passage 201, the first passage portion 43, the throttle 82, the rod chamber 83, the throttle 162, and the variable chamber 191 are in constant communication with the upper chamber 19. In the passage 201, the variable chamber 192 and the communication passage 195 are in constant communication with the lower chamber 20. In the passage 201, the first passage portion 43, the throttle 82, the rod chamber 83, the throttle 162, and the variable chamber 191 allow the oil fluid serving as a working fluid to flow from the upper chamber 19, which is one chamber in the cylinder 2, due to movement of the piston 18 during the extension stroke. In the passage 201, the communication passage 195 and the variable chamber 192 allow the oil fluid serving as a working fluid to flow from the lower chamber 20, which is one chamber in the cylinder 2, due to movement of the piston 18 during the compression stroke. The partition disc 135 including the valve disc 171 is provided in the passage 201.

In the partition disc 135, the inner circumferential side of the valve disc 171 is movable between the disc 132 and the disc 136. The partition disc 135 blocks a flow of oil fluid between the variable chambers 191 and 192 when the inner circumferential side of the valve disc 171 is in contact with the disc 136 over the entire circumference. Also, the partition disc 135 allows the oil fluid to flow between the variable chamber 192 and the variable chamber 191 when the inner circumferential side of the valve disc 171 is separated from the disc 136. The inner circumferential side of the valve disc 171 and the disc 136 constitute a check valve 205. The check valve 205 is provided in the passage 201. The check valve 205 restricts a flow of the oil fluid from the variable chamber 191 to the variable chamber 192 while allowing the oil fluid to flow from the variable chamber 192 to the variable chamber 191. The check valve 205 blocks the passage 201 that allows communication between the upper chamber 19 and the lower chamber 20 during the extension stroke in which a pressure in the upper chamber 19 is higher than a pressure in the lower chamber 20. The check valve 205 brings the entire passage 201 into a communication state during the compression stroke in which the pressure in the lower chamber 20 is higher than the pressure in the upper chamber 19.

The check valve 205 is a free valve in which the entire partition disc 135, which is a valve body, is movable in the axial direction without being clamped. Further, the partition disc 135 may be set such that the entire inner circumference of the valve disc 171 is in constant contact with the disc 136 regardless of the pressure state of the variable chambers 191 and 192. That is, the flow between the variable chambers 191 and 192 may be constantly blocked. That is, the valve disc 171 of the partition disc 135 need only block the flow of the oil fluid in at least one direction of the passage 201.

In the piston rod 21, the annular member 117, the disc 116, the disc 115, the plurality of discs 114, the plurality of discs 113, the disc 112, the disc 111, the piston 18, the disc 51, the damping valve 52, the disc 53, the disc 54, the pilot case 55, the disc 56, the disc 57, the plurality of discs 58, the disc 59, the disc 60, the housing main body 131, the disc 132, the disc 133, and the disc 134 illustrated in FIG. 3 are stacked in that order on the shaft step part 29 with the mounting shaft part 28 inserted through the inside of them. At that time, the pilot case 55 fits the seal member 86 of the damping valve 52 into the outer cylindrical portion 73.

Also, as illustrated in FIG. 4, the partition disc 135 is stacked on the seat part 154 of the housing main body 131 with the mounting shaft part 28 and the discs 133 and 134 inserted through the inside. At this time, the elastic seal member 172 of the partition disc 135 is fitted into the cylindrical portion 153 of the housing main body 131. Further, the disc 136, the disc 137, the disc 138, the disc 139, the disc 140, the disc 141, the disc 142, the disc 143, and the annular member 144 are stacked in that order on the disc 134 and the valve disc 171 of the partition disc 135 with the mounting shaft part 28 inserted through the inside of them.

With the parts from the annular member 117 to the annular member 144 disposed on the piston rod 21 as described above, a nut 211 is screwed onto the male screw 31 illustrated in FIG. 3 of the mounting shaft part 28 that protrudes from the annular member 144. Thereby, the annular member 117, the disc 116, the disc 115, the plurality of discs 114, the plurality of discs 113, the disc 112, the disc 111, the piston 18, the disc 51, the damping valve 52, the disc 53, the disc 54, the pilot case 55, the disc 56, the disc 57, the plurality of discs 58, the disc 59, the disc 60, the housing main body 131, the disc 132, the disc 133, the disc 134, the disc 136, the disc 137, the disc 138, the disc 139, the disc 140, the disc 141, the disc 142, the disc 143, and the annular member 144 are clamped in the axial direction by the shaft step part 29 of the piston rod 21 and the nut 211 at the inner circumferential side of them or in their entirety. At that time, the inner circumferential side of the partition disc 135 is not clamped in the axial direction. In this state, the valve disc 171 of the partition disc 135 is in contact with the seat part 154 of the housing main body 131 and the disc 136 of the support member 181. Also, in this state, in the partition disc 135, the contact parts 176 of the elastic seal member 172 are in contact with the discs 142 with a fastening allowance.

As illustrated in FIG. 1, the base valve 25 described above is provided between the inner cylinder 3 and the bottom member 12 of the outer cylinder 4. The base valve 25 includes a base valve member 221, a disc valve 222, a disc valve 223, and an attachment pin 224. The base valve 25 is placed on the bottom member 12 at the base valve member 221 and is fitted to the inner cylinder 3 at the base valve member 221. The base valve member 221 partitions the lower chamber 20 and the reservoir chamber 6. The disc valve 222 is provided on a lower side of the base valve member 221, that is, on the reservoir chamber 6 side. The disc valve 223 is provided on an upper side of the base valve member 221, that is, on the lower chamber 20 side. The attachment pin 224 attaches the disc valve 222 and the disc valve 223 to the base valve member 221.

The base valve member 221 has an annular shape, and the attachment pin 224 is inserted through a center thereof in the radial direction. A plurality of passage holes 225 and a plurality of passage holes 226 are formed in the base valve member 221. The plurality of passage holes 225 allow the oil fluid to flow between the lower chamber 20 and the reservoir chamber 6. The plurality of passage holes 226 are disposed on an outer side of the plurality of passage holes 225 in a radial direction of the base valve member 221. The plurality of passage holes 226 allow the oil fluid to flow between the lower chamber 20 and the reservoir chamber 6. The disc valve 222 on the reservoir chamber 6 side allows the oil fluid to flow from the lower chamber 20 to the reservoir chamber 6 through the passage holes 225. On the other hand, the disc valve 222 suppresses a flow of the oil fluid from the reservoir chamber 6 to the lower chamber 20 through the passage holes 225. The disc valve 223 allows the oil fluid to flow from the reservoir chamber 6 to the lower chamber 20 through the passage holes 226. On the other hand, the disc valve 223 suppresses a flow of the oil fluid from the lower chamber 20 to the reservoir chamber 6 through the passage holes 226.

The disc valve 222 constitutes a damping valve mechanism 227 with the base valve member 221. The damping valve mechanism 227 opens during the compression stroke of the shock absorber 1 to allow the oil fluid to flow from the lower chamber 20 to the reservoir chamber 6 and generate a damping force. The disc valve 223 constitutes a suction valve mechanism 228 with the base valve member 221. The suction valve mechanism 228 opens during the extension stroke of the shock absorber 1 to allow the oil fluid to flow from the reservoir chamber 6 to the lower chamber 20. Further, the suction valve mechanism 228 performs a function of causing the oil fluid to flow from the reservoir chamber 6 to the lower chamber 20 substantially without generating a damping force so that a shortage of the oil fluid caused mainly due to extension of the piston rod 21 from the cylinder 2 is supplemented.

Next, main operations of the shock absorber 1 will be described.

“In case of assuming that frequency sensitive mechanism 130 does not act, and only first damping force generation mechanism 41 and second damping force generation mechanism 110 on extension side act during extension stroke”

In this case, when a moving speed of the piston 18 (hereinafter referred to as a piston speed) is lower than a first predetermined value, the oil fluid from the upper chamber 19 flows into the lower chamber 20 through the first passage portion 43, the throttle 82, the rod chamber 83, the throttle 92, the back pressure chamber 100, and the fixed orifice 105 illustrated in FIG. 3. Therefore, a damping force having orifice characteristics (in which the damping force is substantially proportional to the square of the piston speed) is generated. Therefore, the damping force characteristics with respect to the piston speed when the piston speed is lower than the first predetermined value are such that an increasing rate of the damping force with respect to an increase in the piston speed is relatively high.

When the piston speed is equal to or higher than the first predetermined value and lower than a second predetermined value, the oil fluid from the upper chamber 19 passes through the first passage portion 43, the throttle 82, the rod chamber 83, the throttle 92, and the back pressure chamber 100, and then flows into the lower chamber 20 through between the disc valve 99 and the valve seat part 75 while opening the disc valve 99. Therefore, a damping force having valve characteristics (in which the damping force is substantially proportional to the piston speed) is generated. Therefore, the damping force characteristics with respect to the piston speed when the piston speed is equal to or higher than the first predetermined value and lower than the second predetermined value are such that an increasing rate of the damping force with respect to an increase in the piston speed is lower than that when the piston speed is lower than the first predetermined value.

When the piston speed increases to the second predetermined value or higher, a relationship of a force (hydraulic pressure) acting on the damping valve 52 is such that a force in an opening direction exerted from the first passage portion 43 is larger than a force in a closing direction exerted from the back pressure chamber 100. Therefore, in this region, as the piston speed increases, the damping valve 52 opens away from the valve seat part 48 of the piston 18. Therefore, the oil fluid from the upper chamber 19 flows from the first passage portion 43 to the lower chamber 20 through between the damping valve 52 and the valve seat part 48 in addition to the flow to the lower chamber 20 through between the disc valve 99 and the valve seat part 75 after passing through the first passage portion 43, the throttle 82, the rod chamber 83, the throttle 92, and the back pressure chamber 100. Therefore, an increasing rate of the damping force with respect to an increase in the piston speed when the piston speed is equal to or higher than the second predetermined value is lower than that when the piston speed is equal to or higher than the first predetermined value and lower than the second predetermined value.

“In case of assuming that frequency sensitive mechanism 130 does not act, and only first damping force generation mechanism 42 on compression side acts during compression stroke”

In this case, when the piston speed is lower than a third predetermined value, the oil fluid from the lower chamber 20 flows into the upper chamber 19 through the first passage portion 44 and the fixed orifice 123 of the disc valve 122 illustrated in FIG. 2. Thereby, a damping force having orifice characteristics is generated. Therefore, the damping force characteristics with respect to the piston speed when the piston speed is lower than the third predetermined value are such that an increasing rate of the damping force with respect to an increase in the piston speed is relatively high.

When the piston speed increases to the third predetermined value or higher, the oil fluid introduced from the lower chamber 20 into the first passage portion 44 flows into the upper chamber 19 through between the disc valve 122 and the valve seat part 49 while opening the disc valve 122. Thereby, a damping force having valve characteristics is generated. Therefore, the damping force characteristics with respect to the piston speed when the piston speed is equal to or higher than the third predetermined value are such that an increasing rate of the damping force with respect to an increase in the piston speed is lower than that when the piston speed is lower than the third predetermined value.

“In case in which frequency sensitive mechanism 130 acts during extension stroke”

In the first embodiment, the frequency sensitive mechanism 130 makes the damping force variable according to the piston frequency even when the piston speed is the same.

In the extension stroke, the oil fluid is introduced from the upper chamber 19 into the variable chamber 191 of the frequency sensitive mechanism 130 through the first passage portion 43, the throttle 82, the rod chamber 83, and the throttle 162 that is illustrated in FIG. 4. Therefore, the valve disc 171 of the partition disc 135 that has been in contact with the seat part 154 and the disc 136 of the support member 181 deforms and moves in a tapered shape in a direction in which the outer circumferential side thereof is separated from the seat part 154 using the contact point with the disc 136 as a fulcrum. At that time, in the partition disc 135, the contact parts 176 of the elastic seal member 172 that are in contact with the stopper member 182 are compressively deformed. Also, at that time, the partition disc 135 discharges the oil fluid from the variable chamber 192 of the frequency sensitive mechanism 130 to the lower chamber 20 through the communication passage 195.

Here, in the extension stroke when the piston frequency is high, the stroke of the piston 18 is small. Therefore, an amount of the oil fluid introduced from the upper chamber 19 into the variable chamber 191 through the first passage portion 43, the throttle 82, the rod chamber 83, and the throttle 162 is small. Therefore, the valve disc 171 of the partition disc 135 deforms as described above, but does not deform to near the limit.

Therefore, during the extension stroke when the piston frequency is high, the valve disc 171 of the partition disc 135 of the frequency sensitive mechanism 130 deforms as described above, and thereby the oil fluid from the upper chamber 19 is introduced into the variable chamber 191 in each extension stroke. Then, a flow rate of the oil fluid flowing from the upper chamber 19 to the lower chamber 20 through the first passage portion 43, the throttle 82, the rod chamber 83, the throttle 92, and the back pressure chamber 100 while opening the second damping force generation mechanism 110 is reduced. Also, in addition to this, a flow rate of the oil fluid flowing from the first passage portion 43 into the lower chamber 20 while opening the first damping force generation mechanism 41 is also reduced. In addition, when the oil fluid is introduced from the upper chamber 19 into the variable chamber 191, an increase in pressure of the back pressure chamber 100 is suppressed compared to a case without the variable chamber 191, and the damping valve 52 of the first damping force generation mechanism 41 becomes easier to open. Thereby, the extension-side damping force generation mechanism becomes soft. Here, the inner circumferential side of the partition disc 135 is separated from the disc 132 and is supported by the disc 136 only from one side. Therefore, the partition disc 135 is easily deformed such that the inner circumferential side approaches the disc 132. Therefore, in the partition disc 135, the contact parts 176 on the outer circumferential side are compressively deformed easily.

Here, in the extension stroke, the valve disc 171 of the partition disc 135 deforms and moves in a tapered shape to the movement restriction member 185 side using the contact point with the disc 136 of the support member 181 as a fulcrum as described above. At the beginning of this deformation movement, the valve disc 171 itself deforms and moves and compressively deforms the contact parts 176 of the elastic seal member 172 that are in contact with the stopper member 182.

When the deformation movement of the valve disc 171 to the movement restriction member 185 side progresses further, the valve disc 171 itself deforms and moves further and compressively deforms the contact parts 176 of the elastic seal member 172 further. At the same time, the valve disc 171 comes into contact with the outer circumferential side of the disc 137 of the support member 181, and causes the outer circumferential side of the disc 137 to be deformed and moved in a tapered shape to the movement restriction member 185 side.

When the deformation movement of the valve disc 171 to the movement restriction member 185 side progresses further, the valve disc 171 itself deforms and moves further and compressively deforms the contact parts 176 of the elastic seal member 172 further. At the same time, the valve disc 171 causes the outer circumferential side of the disc 137 and the outer circumferential side of the disc 138 of the support member 181 to be deformed and moved in a tapered shape to the movement restriction member 185 side.

When the deformation movement of the valve disc 171 to the movement restriction member 185 side progresses further, the valve disc 171 itself deforms and moves further and compressively deforms the contact parts 176 of the elastic seal member 172 further. At the same time, the valve disc 171 causes the outer circumferential side of the disc 137, the outer circumferential side of the disc 138, and the outer circumferential side of the disc 139 of the support member 181 to be deformed and moved in a tapered shape to the movement restriction member 185 side.

When the deformation movement of the valve disc 171 to the movement restriction member 185 side progresses further, the valve disc 171 itself deforms and moves further and compressively deforms the contact parts 176 of the elastic seal member 172 further as illustrated in FIG. 5. At the same time, the valve disc 171 causes the outer circumferential side of the disc 137, the outer circumferential side of the disc 138, the outer circumferential side of the disc 139, and the outer circumferential side of the disc 140 of the support member 181 to be deformed and moved in a tapered shape to the movement restriction member 185 side.

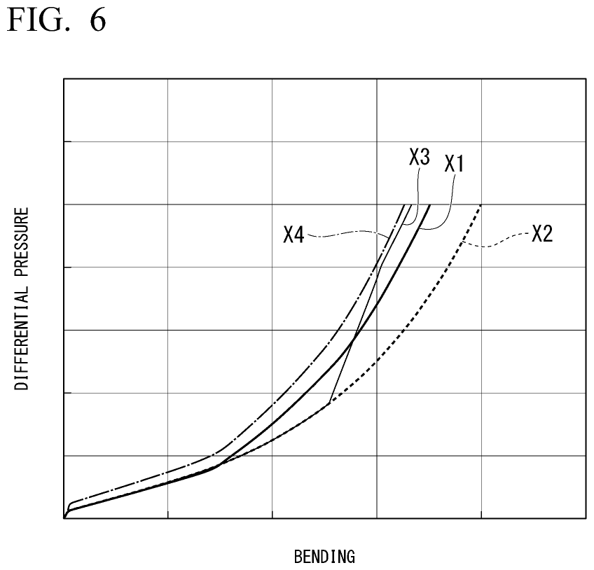

In the support member 181, the plurality of stacked discs 137 to 140 decrease in diameter toward the movement restriction member 185 side, and increase in thickness toward the movement restriction member 185 side. Therefore, a relationship between a bending and a differential pressure of the valve disc 171 is as indicated by the thick solid line X1 in FIG. 6. That is, at the beginning of the deformation movement in which a differential pressure between the variable chamber 191 and the variable chamber 192 is small, the valve disc 171 has a large amount of bending with respect to an increase in differential pressure and is easily bent. Also, the valve disc 171 suppresses the bending becoming excessive even if the differential pressure increases.

On the other hand, during the extension stroke when the piston frequency is low, the stroke of the piston 18 is large. Therefore, an amount of the oil fluid introduced from the upper chamber 19 into the variable chamber 191 through the first passage portion 43, the throttle 82, the rod chamber 83, and the throttle 162 is large. Therefore, although the oil fluid flows from the upper chamber 19 to the variable chamber 191 at the beginning of the stroke of the piston 18, thereafter the valve disc 171 of the partition disc 135 deforms to near the limit and does not deform more than that. As a result, the oil fluid does not flow from the upper chamber 19 to the variable chamber 191. Thereby, a flow rate of the oil fluid flowing from the upper chamber 19 to the lower chamber 20 through the first passage portion 43, the throttle 82, the rod chamber 83, the throttle 92, and the back pressure chamber 100 while opening the second damping force generation mechanism 110 is not reduced. In addition to this, a flow rate of the oil fluid flowing from the first passage portion 43 into the lower chamber 20 while opening the first damping force generation mechanism 41 is neither reduced. In addition, when the oil fluid is not introduced into the variable chamber 191 from the upper chamber 19, the pressure in the back pressure chamber 100 increases, making it difficult for the damping valve 52 of the first damping force generation mechanism 41 to open. Thereby, the damping force on the extension side becomes harder than that when the frequency is high. Even during the extension stroke when the piston frequency is low, the valve disc 171 deforms while deforming the support member 181 in the same manner as when the piston frequency is high.

In the compression stroke, the pressure in the lower chamber 20 increases, but the valve disc 171 of the partition disc 135 of the frequency sensitive mechanism 130 comes into contact with the seat part 154 of the housing main body 131 to suppress expansion of the variable chamber 192. Therefore, an amount of the oil fluid introduced from the lower chamber 20 into the variable chamber 192 through the communication passage 195 is suppressed. As a result, it becomes a state in which a flow rate of the oil fluid introduced from the lower chamber 20 into the first passage portion 44, passing through the first damping force generation mechanism 42, and flowing into the upper chamber 19 is not reduced. Therefore, the damping force becomes hard. In the compression stroke, when the piston speed increases and a pressure in the variable chamber 192 becomes higher than a pressure in the variable chamber 191 by a predetermined value or more, the inner circumferential side of the valve disc 171 of the partition disc 135 separates from the disc 136. In other words, check valve 205 opens. Thereby, the oil fluid flows from the lower chamber 20 to the upper chamber 19 via the communication passage 195, the variable chamber 192, the variable chamber 191, the throttle 162, the rod chamber 83, the throttle 82, and the first passage portion 43. As described above, the valve disc 171 of the partition disc 135 reduces the differential pressure between the variable chamber 192 side and the variable chamber 191 side by opening the check valve 205. Therefore, an excessive bending of the valve disc 171 is suppressed.

Patent Documents 1 and 2 described above describe a shock absorber in which a valve member having a simple support structure that is supported without being clamped is provided in a passage through which a working fluid flows due to movement of a piston. In such a structure, there is a demand to suppress an excessive bending of the valve member when a differential pressure generated in the valve member increases. Therefore, for example, it is assumed to provide a restriction member that comes into contact with the valve member at a radially intermediate position during deformation movement of the valve member to restrict the deformation movement of a portion of the valve member on one side in the radial direction. Then, an amount of change in bending of the valve member with respect to an increase in differential pressure suddenly changes before and after the valve member and the restriction member come into contact with each other. Then, a damping force becomes transient, and ride comfort of a vehicle in which this shock absorber is used deteriorates. Also, with this structure, there is a likelihood that a stress generated in the valve member will increase and durability will decrease. Also, for example, in order to suppress an amount of increase in bending of the valve member due to an increase in the differential pressure, it is assumed that a movement restriction member is provided that is in constant contact with the valve member to restrict the lift, and a rigidity thereof is increased. Then, the valve member is difficult to move. As a result, since an initial timing of movement of the valve member is delayed, resulting in deterioration in the ride comfort of the vehicle in which this shock absorber is used.

In the shock absorber 1 of the first embodiment, the valve disc 171 is provided in the passage 201 through which the oil fluid flows from the upper chamber 19 on one side in the cylinder 2 due to movement of the piston 18 during the extension stroke. The inner circumferential side of the valve disc 171 is supported by the support member 181 only on one surface side without being clamped from both surface sides. The support member 181 is configured such that the second spring constant in the second movement range in which the valve disc 171 moves to the movement restriction member 185 side beyond the first movement range to deform and move the outer circumferential side of the disc 137 is larger than the first spring constant in the first movement range in which the valve disc 171 deforms and moves the contact parts 176. Also, the support member 181 is configured such that the third spring constant in the third movement range in which the valve disc 171 moves to the movement restriction member 185 side beyond the second movement range to deform and move the contact parts 176 and the outer circumferential side of the discs 137 and 138 is larger than the second spring constant in the second movement range in which the valve disc 171 deforms and moves the contact parts 176 and the outer circumferential side of the disc 137. Also, the support member 181 is configured such that the fourth spring constant in the fourth movement range in which the valve disc 171 moves to the movement restriction member 185 side beyond the third movement range to deform and move the contact parts 176 and the outer circumferential side of the discs 137 to 139 is larger than the third spring constant in the third movement range. Further, the support member 181 is configured such that the fifth spring constant in the fifth movement range in which the valve disc 171 moves to the movement restriction member 185 side beyond the fourth movement range to deform and move the contact parts 176 and the outer circumferential side of the discs 137 to 140 is larger than the fourth spring constant in the fourth movement range. In the shock absorber 1, the spring constant of the support member 181 increases in stages in this way. Therefore, the shock absorber 1 can suppress a transient and abrupt change in the bending of the valve disc 171 due to an increase in the differential pressure.

That is, as indicated by the thick solid line X1 in FIG. 6, the valve disc 171 exhibits a smooth characteristic in which a change in the amount of bending with respect to an increase in the differential pressure is small. Therefore, the shock absorber 1 can suppress the damping force becoming transient, and can improve the ride comfort of the vehicle in which the shock absorber 1 is used.

Also, at the beginning of the deformation movement in which the differential pressure between the variable chamber 191 and the variable chamber 192 is small, the valve disc 171 is easily bent due to a large change in the amount of the bending with respect to an increase in the differential pressure. In other words, a low rigidity of the valve disc 171 at the time of the initial bending can be maintained. Therefore, an initial timing of movement of the valve disc 171 is not delayed. This also makes it possible to improve the ride comfort of the vehicle in which the shock absorber 1 is used.

Also, a variable width of the valve disc 171 is not reduced. This also makes it possible to improve the ride comfort of the vehicle in which the shock absorber 1 is used.

Also, since the support member 181 can suppress an excessive bending of the valve disc 171, a stress generated in the valve disc 171 is also reduced, and durability thereof can be enhanced. Therefore, the shock absorber 1 can obtain high reliability while securing performance thereof.

Here, the characteristic X2 indicated by the broken line in FIG. 6 is a case in which a change is made to the shock absorber 1 of the first embodiment such that restriction on bending of the valve disc 171 by the support member is not performed. In this case, when a differential pressure of the valve disc 171 increases, bending of the valve disc 171 becomes larger than that in the shock absorber 1 of the first embodiment, and a stress generated also becomes larger. Therefore, durability of the valve disc 171 decreases than that of the shock absorber 1 of the first embodiment.

Also, the characteristic X3 indicated by the thin solid line in FIG. 6 is a case in which a change is made to the shock absorber 1 of the first embodiment such that restriction on bending of the valve disc 171 is performed by a support member whose spring constant does not change and having a constant and high spring constant similarly to the support member 181. In this case, a change in the amount of bending with respect to an increase in the differential pressure becomes larger than that in the shock absorber 1 of the first embodiment before and after the valve disc 171 comes into contact with the support member. Then, this results in a decrease in the ride comfort of the vehicle compared to that of the shock absorber 1 of the first embodiment.

Also, the characteristic X4 indicated by the dashed-dotted line in FIG. 6 is a case in which a change is made to the shock absorber 1 of the first embodiment such that restriction on bending is performed by increasing a fastening allowance on the movement restriction member 185 side without performing the restriction on bending of the valve disc 171 by the support member. In this case, at the beginning of the deformation movement in which the differential pressure of the valve disc 171 is small, an amount of the bending is small even with the same differential pressure, and it is difficult to bend. Therefore, the initial timing of movement of the valve disc 171 is delayed compared to that of the shock absorber 1 of the first embodiment. Then, this results in a decrease in the ride comfort of the vehicle compared to that of the shock absorber 1 of the first embodiment.

In the shock absorber 1 of the first embodiment, the movement restriction member 185 and the valve disc 171 are in constant contact with each other. Therefore, in the shock absorber 1, the valve disc 171 and the movement restriction member 185 do not change from a separated state to a state in which they come into contact with each other. Therefore, a change in characteristics before and after the contact can be suppressed.

In the shock absorber 1 of the first embodiment, the movement restriction member 185 is formed of the stopper member 182 and the contact parts 176 of the elastic seal member 172 that is movable or extendable and contractible. Therefore, in the shock absorber 1, the contact parts 176 move or extend and contract to suppress deformation of the valve disc 171 when the valve disc 171 is deformed.

In the shock absorber 1 of the first embodiment, the elastic seal member 172 is provided integrally with the valve disc 171. Thereby, the shock absorber 1 can reduce the number of parts and improve productivity.

In the shock absorber 1 of the first embodiment, the support member 181 is formed by stacking the plurality of discs 136 to 141. Therefore, in the shock absorber 1, the bending characteristics of the valve disc 171 can be easily adjusted by changing each specification of the discs 136 to 141.

In the shock absorber 1 of the first embodiment, the plurality of discs 137 to 140 have a smaller outer diameter on the movement restriction member 185 side than on the valve disc 171 side. Therefore, the shock absorber 1 can easily have characteristics in which the rigidity of the support member 181 is low at the time of the initial bending of the valve disc 171, and the rigidity increases according to an amount of bending (an amount of lift) of the valve disc 171.

In the shock absorber 1 of the first embodiment, the plurality of discs 137 to 140 have a larger plate thickness on the movement restriction member 185 side than on the valve disc 171 side. Therefore, the shock absorber 1 can have characteristics in which the rigidity of the support member 181 is low at the time of the initial bending of the valve disc 171, and the rigidity increases according to an amount of bending (an amount of lift) of the valve disc 171.

In the shock absorber 1 of the first embodiment, the valve disc 171 is disposed in the cylindrical portion 153 of the housing 145 with the piston rod 21 inserted through the inner circumferential side, and the seal part 175 of the elastic seal member 172 that is in sliding contact with the cylindrical portion 153 while closing the gap between itself and the cylindrical portion 153 is provided on the outer circumferential side of the valve disc 171. Thereby, the shock absorber 1 can easily make the damping force variable in response to the piston frequency using the valve disc 171 and the elastic seal member 172.

### Second Embodiment

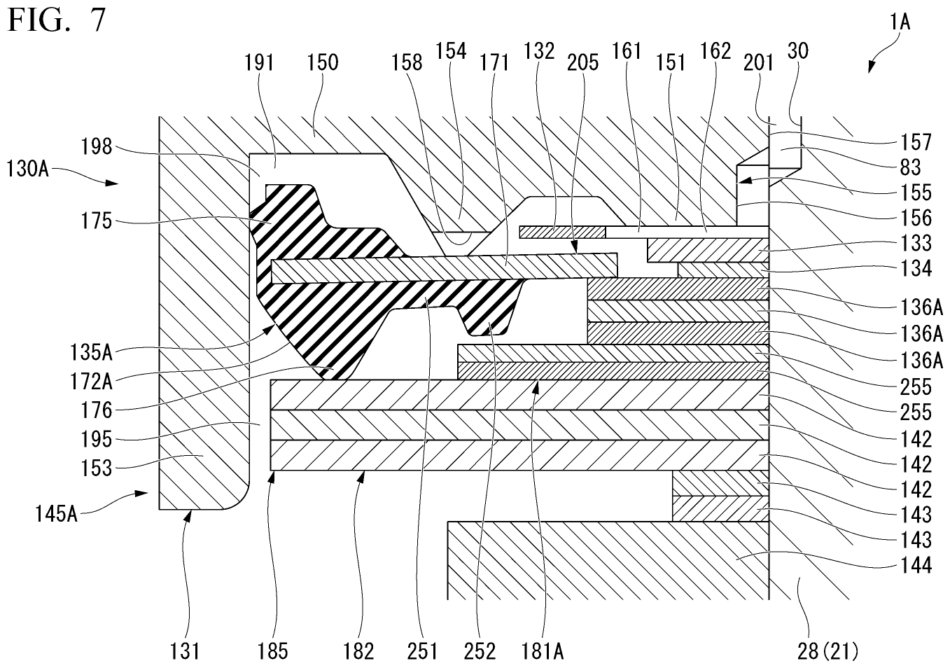

Next, a second embodiment will be described mainly on the basis of FIG. 7, focusing on differences from the first embodiment. Further, parts common to those in the first embodiment will be denoted by the same terms and the same reference signs.

As illustrated in FIG. 7, a shock absorber 1A of the second embodiment includes a frequency sensitive mechanism 130A, which is partially different from the frequency sensitive mechanism 130, instead of the frequency sensitive mechanism 130.

The frequency sensitive mechanism 130A includes a partition disc 135A, which is partially different from the partition disc 135, instead of the partition disc 135. The partition disc 135A includes an elastic seal member 172A, which is partially different from the elastic seal member 172, instead of the elastic seal member 172.

The elastic seal member 172A includes a connection part 251 and a protruding part 252 in addition to the seal part 175 and the contact part 176. The connection part 251 and the protruding part 252 are also adhered to a valve disc 171 similarly to the seal part 175 and the contact part 176. The seal part 175, the contact part 176, the connection part 251, and the protruding part 252 are formed seamlessly and integrally and baked into the valve disc 171.

The connection part 251 extends from an inner circumferential portion of the contact part 176 on the valve disc 171 side in an axial direction to an inner side of the valve disc 171 in a radial direction. A height of the connection part 251 from the valve disc 171 in an axial direction of the valve disc 171 is lower than that of the contact part 176.

The protruding part 252 is provided on an inner side of the valve disc 171 in the radial direction from an inner circumferential portion of the connection part 251. The protruding part 252 has an annular shape. A height of the protruding part 252 from the valve disc 171 in the axial direction of the valve disc 171 is lower than that of the contact part 176 and higher than that of the connection part 251. Further, the protruding part 252 may be provided intermittently in a circumferential direction of the valve disc 171 instead of having an annular shape.

The frequency sensitive mechanism 130A includes a support member 181A that is partially different from the support member 181. The support member 181A includes a plurality of (specifically, three) discs 136A and a plurality of (specifically, two) discs 255 instead of the discs 136 to 141.

The discs 136A are made of a metal and each have a bored circular flat plate shape with a constant thickness. A mounting shaft part 28 of a piston rod 21 is fitted to an inner side of the disc 136A.

The disc 136A has an outer diameter that is the same as the outer diameter of the disc 136. The disc 136A has a thickness larger than the thickness of disc 136.

The discs 255 are made of a metal and each have a bored circular flat plate shape with a constant thickness. The mounting shaft part 28 of the piston rod 21 is fitted to an inner side of the discs 255. The disc 255 has an outer diameter larger than the outer diameter of the disc 136A and larger than an outer diameter of a distal end surface of the protruding part 252.

The plurality of (specifically, three) discs 136A are stacked on the discs 142 side of the valve disc 171 in the axial direction, and the plurality of (specifically, two) discs 255 are stacked on the discs 142 side. At this time, the discs 136A are in contact with a disc 134 and the valve disc 171, and the discs 255 are in contact with the discs 142.

The discs 132 to 134, 136A, 255, 142, and a housing main body 131 constitute a housing 145A of the frequency sensitive mechanism 130A.

In the protruding part 252 of the partition disc 135A, an inner diameter of a distal end surface on a side opposite to the valve disc 171 in the axial direction is larger than the outer diameter of the disc 136A. An outer diameter of the distal end surface of the protruding part 252 is smaller than the outer diameter of the disc 255. A height of the protruding part 252 from the valve disc 171 in the axial direction is lower than a total height of the three discs 136A. When a variable chamber 191 and a variable chamber 192 have the same pressure as each other, the protruding part 252 of the partition disc 135A faces the disc 255 with a gap in the axial direction of the disc 255.

The discs 136A and 255, the contact part 176, and the protruding part 252 constitute the support member 181A.

In the shock absorber 1A, at the beginning of deformation movement to a movement restriction member 185 side, the valve disc 171 itself deforms and moves and compressively deforms the contact part 176 that is in contact with a stopper member 182. A movement range during this deformation movement of the valve disc 171 is defined as a sixth movement range. A spring constant of the support member 181A in the sixth movement range is a spring constant of the contact part 176. This spring constant is defined as a sixth spring constant.

When the deformation movement of the valve disc 171 to the movement restriction member 185 side progresses further, the valve disc 171 itself deforms and moves beyond the sixth movement range, and compressively deforms the contact part 176 of the elastic seal member 172 beyond the sixth movement range. At the same time, the valve disc 171 causes the protruding part 252 of the support member 181A to come into contact with the disc 255 of the support member 181A to compressively deform it. A movement range during this deformation movement of the valve disc 171 is defined as a seventh movement range. A spring constant of the support member 181A in the seventh movement range is defined as a seventh spring constant. Then, the seventh spring constant is a combined spring constant of the spring constant of the contact part 176 and the spring constant of the protruding part 252, and is larger than the sixth spring constant. In other words, a rigidity of the support member 181A when the valve disc 171 is in the seventh movement range is higher than a rigidity thereof when the valve disc 171 is in the sixth movement range.

Also in the shock absorber 1A of the second embodiment, the support member 181A is configured such that the seventh spring constant in the seventh movement range in which the valve disc 171 moves to the movement restriction member 185 side beyond the sixth movement range to deform and move the protruding part 252 is larger than the sixth spring constant in the sixth movement range in which the valve disc 171 deforms and moves the contact part 176. Also in the shock absorber 1A, the spring constant of the support member 181A increases in stages in this way. Therefore, the shock absorber 1A can also suppress a transient and abrupt change in the bending of the valve disc 171 due to an increase in the differential pressure. Therefore, the shock absorber 1A can also improve ride comfort of a vehicle in which the shock absorber 1A is used.

Also, since the shock absorber 1A can also maintain a low rigidity of the valve disc 171 at the time of the initial bending, an initial timing of movement of the valve disc 171 is not delayed. This also makes it possible to improve the ride comfort of the vehicle in which the shock absorber 1A is used.

Since the shock absorber 1A also does not reduce a variable width of the valve disc 171, this also makes it possible to improve the ride comfort of the vehicle in which the shock absorber 1A is used.

Also, since the support member 181A can suppress an excessive bending of the valve disc 171, durability of the valve disc 171 can be enhanced.

### Third Embodiment

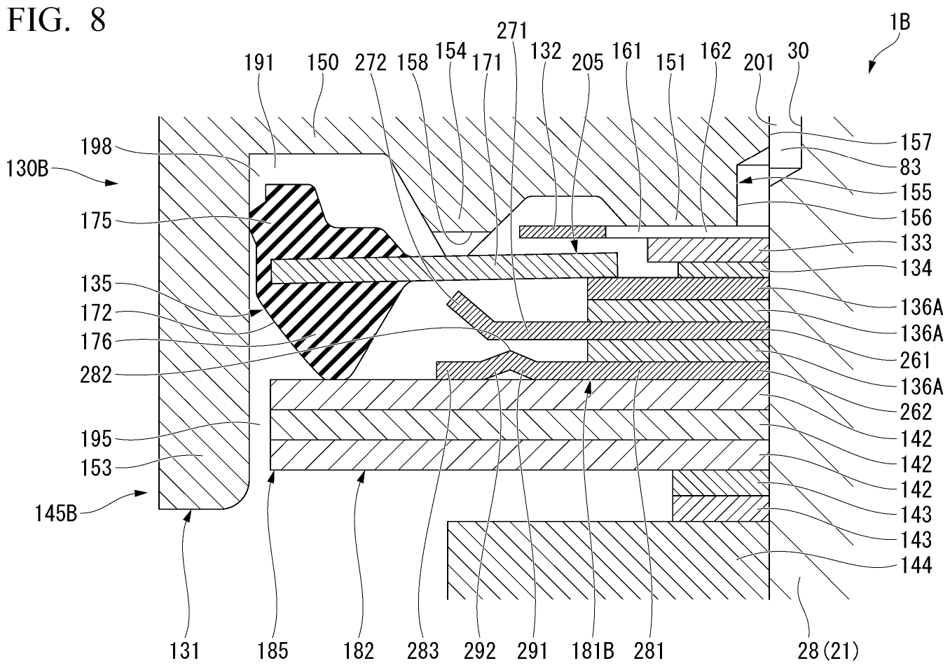

Next, a third embodiment will be described mainly on the basis of FIG. 8, focusing on differences from the first and second embodiments. Further, parts common to those in the first and second embodiments will be denoted by the same terms and the same reference signs.

As illustrated in FIG. 8, a shock absorber 1B of the third embodiment includes a frequency sensitive mechanism 130B, which is partially different from the frequency sensitive mechanism 130, instead of the frequency sensitive mechanism 130.

The frequency sensitive mechanism 130B includes a support member 181B, which is partially different from the support member 181, instead of the support member 181. The support member 181B includes a plurality of (specifically, three) discs 136A that are similar to those of the second embodiment, one disc 261, and one disc 262 instead of the discs 136 to 141.

Both the discs 261 and 262 are made of a metal. Both the discs 261 and 262 have a bored disc shape. A mounting shaft part 28 of a piston rod 21 is fitted to an inner side of both the discs 261 and 262.

The disc 261 includes a base plate part 271 and a protruding plate part 272.

The base plate part 271 has a bored circular flat plate shape with a constant thickness. The disc 261 has the mounting shaft part 28 of the piston rod 21 fitted to an inner side of the base plate part 271. The protruding plate part 272 extends outward in a radial direction of the base plate part 271 from an outer circumferential edge portion of the base plate part 271. The protruding plate part 272 becomes further away from the base plate part 271 to one side in an axial direction of the base plate part 271 toward the outside in the radial direction of the base plate part 271. The protruding plate part 272 extends from the outer circumferential edge portion of the base plate part 271 to one side in the axial direction of the base plate part 271 while increasing a diameter thereof. The protruding plate part 272 is tapered and has an annular shape. Further, the protruding plate part 272 may be provided intermittently in a circumferential direction of the base plate part 271 instead of having an annular shape.

The protruding plate part 272 has an outer diameter smaller than a minimum inner diameter of a contact part 176 of a partition disc 135. The protruding plate part 272 has an inner diameter larger than an outer diameter of the disc 136A.

The disc 262 includes an inner base plate part 281, a contact plate part 282, and an outer base plate part 283.

The inner base plate part 281 has a bored circular flat plate shape with a constant thickness. The disc 262 has the mounting shaft part 28 of the piston rod 21 fitted to an inner side of the inner base plate part 281.

The contact plate part 282 includes an inner plate part 291 and an outer plate part 292.

The inner plate part 291 extends outward in a radial direction of the inner base plate part 281 from an outer circumferential edge portion of the inner base plate part 281. The inner plate part 291 becomes further away from the inner base plate part 281 to one side in an axial direction of the inner base plate part 281 toward the outside in the radial direction of the inner base plate part 281. The inner plate part 291 extends from the outer circumferential edge portion of the inner base plate part 281 to one side in the axial direction of the inner base plate part 281 while increasing a diameter thereof. The inner plate part 291 is tapered and has an annular shape.

The outer plate part 292 extends outward in a radial direction of the inner plate part 291 from an outer circumferential edge portion of the inner plate part 291. The outer plate part 292 is positioned further toward the inner base plate part 281 side in an axial direction of the inner plate part 291 from the inner plate part 291 toward the outside in the radial direction of the inner plate part 291. The outer plate part 292 extends from the outer circumferential edge portion of the inner plate part 291 to the inner base plate part 281 side in the axial direction of the inner plate part 291 while increasing a diameter thereof. The outer plate part 292 is tapered and has an annular shape.

The outer base plate part 283 extends outward in a radial direction of the outer plate part 292 from an outer circumferential edge portion of the outer plate part 292. The outer base plate part 283 has a circular flat plate shape with a constant thickness. The outer base plate part 283 is disposed on the same plane as the inner base plate part 281. The contact plate part 282 protrudes from the inner base plate part 281 and the outer base plate part 283 to one side thereof in the axial direction.

The outer base plate part 283 has an outer diameter smaller than the minimum inner diameter of the contact parts 176 of the partition disc 135. The outer base plate part 283 has an outer diameter larger than the outer diameter of the protruding plate part 272. In the contact plate part 282, a diameter of a distal end portion of the contact plate part 282 farthest from the inner base plate part 281 and the outer base plate part 283 in the axial direction is smaller than an outer diameter of the base plate part 271. The inner plate part 291 of the contact plate part 282 has an inner diameter larger than the outer diameter of the disc 136A.

The plurality of (specifically, two) discs 136A are stacked on a disc 142 side of the valve disc 171 and the disc 134 in the axial direction. At that time, the discs 136A are in contact with the valve disc 171 and the disc 134. Also, the disc 261 is disposed on the disc 142 side of these discs 136A in the axial direction to be in contact with the discs 136A at the base plate part 271. At that time, the disc 261 is directed such that the protruding plate part 272 protrudes from the base plate part 271 to the valve disc 171 side in the axial direction of the base plate part 271.

One disc 136A is disposed on a side of the base plate part 271 of the disc 261 opposite to the valve disc 171 in the axial direction to be in contact with the base plate part 271. Also, the disc 262 is disposed on a side of this disc 136A opposite to the valve disc 171 in the axial direction to be in contact with the disc 136A at the inner base plate part 281. At this time, the disc 262 is directed such that the contact plate part 282 protrudes from the inner base plate part 281 and the outer base plate part 283 to the valve disc 171 side in the axial direction thereof. The inner base plate part 281 and the outer base plate part 283 of the disc 262 are in contact with the disc 142.

The discs 132 to 134, 136A, 261, 262, and 142, and a housing main body 131 constitute a housing 145B of the frequency sensitive mechanism 130B.

The discs 136A, 261, and 262, and the contact part 176 constitute a support member 181B.

In the shock absorber 1B, at the beginning of deformation movement to a movement restriction member 185 side, the valve disc 171 itself deforms and moves and compressively deforms the contact part 176 of an elastic seal member 172 that is in contact with a stopper member 182. A movement range during this deformation movement of the valve disc 171 is defined as an eighth movement range. A spring constant of the contact part 176 of the support member 181B in the eighth movement range is defined as an eighth spring constant.

When the deformation movement of the valve disc 171 to the movement restriction member 185 side progresses further, the valve disc 171 itself deforms and moves beyond the eighth movement range, and compressively deforms the contact part 176 of the elastic seal member 172 beyond the eighth movement range. At the same time, the valve disc 171 comes into contact with the protruding plate part 272 of the disc 261 of the support member 181B to cause the base plate part 271 of the disc 261 to be deformed in a tapered shape. A movement range during this deformation movement of the valve disc 171 is defined as a ninth movement range. A spring constant of the support member 181B in the ninth movement range is defined as a ninth spring constant. Then, the ninth spring constant is a combined spring constant of the spring constant of the contact part 176 and the spring constant of the base plate part 271, and is larger than the eighth spring constant. In other words, a rigidity of the support member 181B when the valve disc 171 is in the ninth movement range is higher than a rigidity thereof when the valve disc 171 is in the eighth movement range.

When the deformation movement of the valve disc 171 to the movement restriction member 185 side progresses further, the valve disc 171 itself deforms and moves beyond the ninth movement range, and compressively deforms the contact part 176 of the elastic seal member 172 beyond the ninth movement range. At the same time, the valve disc 171 causes the base plate part 271 of the disc 261 of the support member 181B to come into contact with the contact plate part 282 of the disc 262, and then deforms the protruding plate part 272 of the disc 261 to increase the taper. A movement range during this deformation movement of the valve disc 171 is defined as a tenth movement range. A spring constant of the support member 181B in the tenth movement range is defined as a tenth spring constant. Then, the tenth spring constant is a combined spring constant of the spring constant of the contact part 176 and the spring constant of the protruding plate part 272, and is larger than the ninth spring constant. In other words, a rigidity of the support member 181B when the valve disc 171 is in the tenth movement range is higher than a rigidity thereof when the valve disc 171 is in the ninth movement range.

Also in the shock absorber 1B of the third embodiment, the support member 181B is configured such that the ninth spring constant in the ninth movement range in which the valve disc 171 moves to the movement restriction member 185 side beyond the eighth movement range to deform and move the base plate part 271 of the disc 261 is larger than the eighth spring constant in the eighth movement range in which the valve disc 171 deforms and moves the contact part 176. Also, the support member 181B is configured such that the tenth spring constant in the tenth movement range in which the valve disc 171 moves to the movement restriction member 185 side beyond the ninth movement range to deform and move the protruding plate part 272 of the disc 261 is larger than the ninth spring constant in the ninth movement range in which the valve disc 171 deforms and moves the base plate part 271 of the disc 261. Also in the shock absorber 1B, the spring constant of the support member 181B increases in stages in this way. Therefore, the shock absorber 1B can also suppress a transient and abrupt change in the bending of the valve disc 171 due to an increase in the differential pressure. Therefore, the shock absorber 1B can also improve ride comfort of a vehicle in which the shock absorber 1B is used.

Also, since the shock absorber 1B can also maintain a low rigidity of the valve disc 171 at the time of the initial bending, an initial timing of movement of the valve disc 171 is not delayed. This also makes it possible to improve the ride comfort of the vehicle in which the shock absorber 1B is used.

Since the shock absorber 1B also does not reduce a variable width of the valve disc 171, this also makes it possible to improve the ride comfort of the vehicle in which the shock absorber 1B is used.

Also, since the support member 181B can suppress an excessive bending of the valve disc 171, durability of the valve disc 171 can be enhanced.

Further, although the support member 181B has used the disc 261 having non-linear spring characteristics, it is also possible to use a plurality of coil springs or a coil spring having non-linear spring characteristics in place of the discs 261 and 262.

In the first to third embodiments described above, the movement restriction member 185 has been described using a case in which the contact part 176, which is an elastic member, is integrally provided on the stopper member 182 side of the valve disc 171 as an example. The present invention is not limited thereto, and the contact part 176, which is an elastic member, may be integrally provided on the valve disc 171 side of the stopper member 182 without providing it on the valve disc 171.

In the first to third embodiments described above, an example in which the present invention has been applied to a dual-tube type hydraulic shock absorber has been described, but the present invention is not limited thereto. The present invention may be applied to a mono-tube type hydraulic shock absorber without an outer cylinder. In a mono-tube type hydraulic shock absorber, a slidable partition is provided on a side of the lower chamber opposite to the upper chamber in the cylinder. Then, a side of the partition opposite to the lower chamber in the cylinder is defined as a gas chamber.

Also, in the first to third embodiments, the present invention has been applied to the frequency sensitive mechanisms 130, 130A, and 130B, but the present invention may be applied to the first damping force generation mechanism 41. The first damping force generation mechanism 41 includes the back pressure chamber 100 into which the oil fluid is introduced from the upper chamber 19 on an upstream side in the extension stroke and applying an internal pressure to the damping valve 52 in a valve closing direction. When the present invention is applied to the first damping force generation mechanism 41, the valve member serves as the damping valve 52 that provides a resistance force to a flow of the oil fluid from the upper chamber 19 on the upstream side of the first passage portion 43 to the lower chamber 20 on a downstream side thereof in the extension stroke. Then, the spring constant of the second movement range in which the damping valve 52 moves to the bottom portion 71 side beyond the first movement range is higher than the spring constant of the first movement range in which the damping valve 52 moves to the bottom portion 71 side of the pilot case 55, which serves as a movement restriction member, with respect to the support member supporting the damping valve 52.

Also, it is also possible to provide the frequency sensitive mechanisms 130, 130A, and 130B to operate in the compression stroke in the same manner as in the extension stroke described above. In this case, the variable chamber 191 is in constant communication with the lower chamber 20, and the variable chamber 192 is in constant communication with the upper chamber 19.

Also, the present invention can also be applied to the base valve 25 described above.

Also, when an oil passage communicating with the inside of the cylinder 2 is provided outside the cylinder 2 and a damping force generation mechanism is provided in the oil passage, the present invention can also be applied to a valve member of the damping force generation mechanism or the like.

Also, in the first to third embodiments described above, a hydraulic shock absorber has been described as an example, but water or air can also be used as a fluid.

### INDUSTRIAL APPLICABILITY

According to the above-described aspects of the present invention, it is possible to provide a shock absorber capable of improving ride comfort of a vehicle. Therefore, industrial applicability is high.

### REFERENCE SIGNS LIST

1, 1A, 1B Shock absorber
2 Cylinder
18 Piston
19 Upper chamber (chamber)
20 Lower chamber (chamber)
21 Piston rod (shaft member)
52 Damping valve
100 Back pressure chamber
136 to 141 Disc (plate-shaped member)
153 Cylindrical portion
171 Valve disc (valve member)
172 Elastic seal member (elastic member, seal member)
181, 181A, 181B Support member
182 Stopper member
185 Movement restriction member
201 Passage

1. A shock absorber comprising:
a cylinder in which a working fluid is sealed;
a piston fitted in the cylinder to be slidable and partitioning an inside of the cylinder into two chambers;
a passage through which the working fluid flows from one chamber in the cylinder due to movement of the piston;
a bendable plate-shaped valve member provided in the passage and whose inner circumferential side is supported by a support member only on one surface side without being clamped from both surface sides; and
a movement restriction member restricting movement of the valve member, wherein
the support member is configured such that a spring constant of a second movement range in which the valve member moves to the movement restriction member side beyond a first movement range is larger than a spring constant of the first movement range in which the valve member moves to the movement restriction member side.

2. The shock absorber according to claim 1, wherein the movement restriction member and the valve member are in constant contact with each other.

3. The shock absorber according to claim 1, wherein the movement restriction member includes a stopper member and an elastic member which is movable or extendable and contractible.

4. The shock absorber according to claim 3, wherein the elastic member is provided integrally with the valve member.

5. The shock absorber according to claim 3, wherein the elastic member is provided integrally with the stopper member.

6. The shock absorber according to claim 1, wherein the support member is formed by stacking a plurality of plate-shaped members.

7. The shock absorber according to claim 6, wherein the plurality of plate-shaped members have a smaller outer diameter on the movement restriction member side than on the valve member side.

8. The shock absorber according to claim 7, wherein the plurality of plate-shaped members have a larger plate thickness on the movement restriction member side than on the valve member side.

9. The shock absorber according to claim 1, wherein
the valve member is disposed in a cylindrical portion with a shaft member inserted through an inner circumferential side thereof, and
a seal member which is in sliding contact with the cylindrical portion while closing a gap between itself and the cylindrical portion is provided on an outer circumferential side of the valve member.

10. The shock absorber according to claim 1, wherein
the valve member serves as a damping valve configured to provide a resistance force to a flow of the working fluid from a chamber on an upstream side to a chamber on a downstream side of the passage, and
a back pressure chamber into which the working fluid is introduced from the chamber on the upstream side and applying an internal pressure to the valve member in a valve closing direction is provided.

11. The shock absorber according to claim 1, wherein the support member is a plurality of coil springs or a coil spring having non-linear characteristics.
